(19) United States
(12) Patent Application Publication
(10) Pub. No.: US 2025/0337277 A1
(43) Pub. Date: Oct. 30, 2025

(54) Stability Enhancements for Large Area Wireless Power Transfer Systems

(71) Applicant: NuCurrent, Inc., Chicago, IL (US)

(72) Inventors: Anna Greszta, Chicago, IL (US); Julia Luzinski, Chicago, IL (US); Alireza Dayerizadeh, Huntington Beach, CA (US); Reza Tavakoli, Fremont, CA (US)

(21) Appl. No.: 18/647,976

(22) Filed: Apr. 26, 2024

(51) Int. Cl. H02J 50/10

(52) U.S. Cl. CPC H02J 50/10

(57) ABSTRACT

A wireless power transmission system includes an input stabilization system, a controller, an amplifier, and an antenna. The input power stabilization system includes a proportional integral (PI) controller and is configured to receive an input power from an external power source and generate a stabilized direct current (DC) power based on a desired input power. The controller is configured to generate a driving signal for alternating current (AC) wireless signals, the AC wireless signals including wireless power signals. The amplifier is configured to (i) receive the stabilized DC power and antenna driving signals, (ii) invert the stabilized DC power based on the driving signals to generate alternating current (AC) wireless signals. The antenna is configured to transmit the AC wireless signals when driven by the amplifier.

### BACKGROUND

Wireless connection systems are used in a variety of applications for the wireless transfer of electrical energy, electrical power, electromagnetic energy, and/or electrical data signals. Such wireless connection systems often use inductive wireless power transfer, which occurs when magnetic fields created by a transmitting element induce an electric field, and hence, an electric current, in a receiving element. These transmitting and receiving elements will often take the form of an antenna, such as coiled wires, and the like.

### SUMMARY

In one aspect, the disclosed technology may take the form of a wireless power transmission system that includes an input stabilization system, a controller, an amplifier, and an antenna. The input power stabilization system includes a proportional integral (PI) controller and is configured to receive an input power from an external power source and generate a stabilized direct current (DC) power based on a desired input power. The controller includes at least one processor, at least one machine-readable medium, and program instructions stored on the at least one machine-readable medium. The program instructions, when executed by the at least one processor, cause the controller to generate a driving signal for alternating current (AC) wireless signals, the AC wireless signals including wireless power signals. The amplifier is configured to (i) receive the stabilized DC power and antenna driving signals, (ii) invert the stabilized DC power based on the driving signals to generate alternating current (AC) wireless signals. The antenna is configured to transmit the AC wireless signals when driven by the amplifier.

The foregoing wireless power transmission system may further involve additional functionality and/or components. For example, the wireless power transmission system may further include a power input port that includes one or more of a universal serial bus (USB) Type-A port, a USB-micro port, a USB Type-B port, or combinations thereof.

The foregoing input power stabilization system may further involve additional functionality and/or components. For example, the input power stabilization system may further include an input current sensing circuit configured to continuously determine an input current of the input power over time. In some further examples, the input power stabilization system may further include a differentiator circuit that is configured to (i) receive the input current of the input power over time, (ii) define a reference value for a stabilized input current, (iii) compare the input current of the input power over time with the reference value for the stabilized input current, and (iv) determine and output an error value based on comparison of the input current of the input power over time with the reference value for the stabilized input current.

The foregoing PI controller may further involve additional functionality and/or components. For example, the PI controller may be configured to (i) receive the error value and (ii) determine and output the stabilized DC power based on the error value. In some additional or alternative examples, the PI controller may further include an inversion circuit. In some additional or alternative examples, the PI controller may further include an upper saturation circuit. In some additional or alternative examples, the PI controller may further include an lower saturation circuit.

Still further, the functionality carried out by the controller may include various additional functionality. For example, the program instructions stored on the at least one machine-readable medium which, when executed by the at least one processor, further cause the controller to decode data signals that are encoded in the AC wireless signals based on a period-length encoding scheme, the period-length encoding scheme starting at least one message of the data signals with a leading edge and ending the at least one message of the data signals with a trailing edge. In some further examples, the wireless power transmission system may further include at least one sensor and a demodulation circuit. The at least one sensor may be configured to detect electrical information associated with electrical characteristics of the AC wireless signals at the antenna, the electrical information including one or more of a current of the AC wireless signals, a voltage of the AC wireless signals, a power level of the AC wireless signals, or combinations thereof. The demodulation circuit may be configured to (i) receive the electrical information from the at least one sensor, (ii) detect a change in the electrical information, (iii) determine if the change in the electrical information meets or exceeds one of a rise threshold or a fall threshold, (iv) if the change exceeds one of the rise threshold or the fall threshold, generate an alert, (v) and output a plurality of data alerts. In such examples, the controller may be configured to receive the plurality of data alerts and the program instructions stored on the at least one machine-readable medium, when executed by the at least one processor, cause the controller to decode data signals that are encoded in the AC wireless signals comprises decoding the plurality of data alerts.

In another aspect, disclosed herein is a method of operating the a wireless transmission system to carry out the functions disclosed herein, including but not limited to the functions of the foregoing wireless transmission system.

One of ordinary skill in the art will appreciate these as well as numerous other aspects in reading the following disclosure.

### BRIEF DESCRIPTION OF THE DRAWINGS

FIG. 1A is a block diagram of an embodiment of a system for wirelessly transferring one or more of electrical power, electronic data, or combinations thereof.

FIG. 1B is another block diagram of an embodiment of the system of FIG. 1A.

FIG. 2 is a block diagram further illustrating components of a wireless transmission system of the system of FIGS. 1A-B.

FIG. 3 is a block diagram illustrating components of a sensing system of the wireless transmission system of FIGS. 1-2.

FIG. 4A is a block diagram illustrating components of a demodulation circuit for the wireless transmission system of FIGS. 1-3.

FIG. 4B is a first portion of a schematic circuit diagram for the demodulation circuit of FIG. 4A.

FIG. 4C is a second portion of the schematic circuit diagram for the demodulation circuit of FIGS. 4A and 4B.

FIG. 5A is a timing diagram for voltages of an electrical signal, as it travels through the demodulation circuit.

FIG. 5B is a timing diagram for a data signal transmitted in accordance with a period-length based data encoding scheme.

FIG. 6A is a block diagram illustrating components of a first power conditioning system of the wireless transmission system of FIGS. 1-2.

FIG. 6B is a block diagram illustrating components of a second power conditioning system of the wireless transmission system of FIGS. 1-2.

FIG. 6C is a block diagram illustrating components of an input power stabilization system of the power conditioning system of FIG. 6B.

FIG. 6D is a schematic diagram of an example circuit for implementing a proportional integration controller of the input power stabilization system of FIG. 6C.

FIG. 6E is a schematic diagram of an example circuit for implementing a precision voltage limiter of the input power stabilization system of FIG. 6C.

FIG. 7 is a block diagram illustrating components of the wireless receiver system of FIG. 1.

FIG. 8A is a top view of an embodiment of an antenna, for use as one or more of a transmitter antenna and/or a receiver antenna of the systems of FIGS. 1-4C, 6, and 7.

FIG. 8B is a top view of another embodiment of an antenna, for use as one or more of a transmitter antenna and/or a receiver antenna of the systems of FIGS. 1-4C, 6, and 7.

FIG. 9A is a top view of a wireless power transmission antenna having a source coil and an internal repeater coil, for use as a transmitter antenna of the systems of FIGS. 1-5C, 6, and 7.

FIG. 9B is a top view of another wireless power transmission antenna having a source coil and an internal repeater coil, for use as a transmitter antenna of the systems of FIGS. 1-5C, 6, and 7.

FIG. 9C is a top view of yet another wireless power transmission antenna having a source coil and an internal repeater coil, for use as a transmitter antenna of the systems of FIGS. 1-5C, 6, and 7.

FIG. 10 is a block diagram for a method of operating a wireless power transmission system, such as those disclosed with respect to FIGS. 1-4C and 6-9B.

FIG. 11 is a block diagram for a method of operating a wireless power receiver system, such as those disclosed with respect to FIGS. 1-4C and 6-9B.

FIG. 12 is a side perspective view of an example mouse and mouse pad, within which the systems disclosed herein may be integrated, in accordance with FIGS. 1-30 and the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto. Additional, different, or fewer components and methods may be included in the systems and methods.

### DETAILED DESCRIPTION

Near field magnetic induction (NFMI) is often utilized for wireless power transfer. NFMI enables the transfer of signals wirelessly through magnetic that induces a current between a transmitter antenna and a receiver antenna coupled with the transmitter antenna. To that end, NFMI may be referred to as “inductive coupling,” which may be a wireless power transmission technique that utilizes an alternating electromagnetic field to transfer electrical energy between two antennas.

NFMI utilizes this coupling between antennas, in the near field, for wireless transmission of magnetic energy between two magnetically coupled coils that are tuned to resonate at a similar frequency. Such near-field magnetic coupling may enable wireless power transmission via resonant transmission of confined magnetic fields. This near-field magnetic coupling may provide connection via “mutual inductance,” which refers to the production of an electromotive force in a circuit by a change in current in at least one other circuit magnetically coupled to the first.

To facilitate NFMI, the inductor coils of either the transmitter antenna or the receiver antenna are strategically positioned to facilitate reception and/or transmission of wirelessly transferred electrical signals, via NFMI.

Transmission of one or more of electrical energy, electrical power, electromagnetic energy and/or electronic data signals from one of such coiled antennas to another, generally, operates at an operating frequency and/or an operating frequency range. An operating frequency, generally, refers to the frequency at which antennas of a wireless system are tuned to for purposes of wireless power and/or data transfer. The operating frequency may be selected for any of a variety of reasons, such as, but not limited to, power transfer efficiency characteristics, power level characteristics, self-resonant frequency restraints, design requirements, adherence to standards bodies' required characteristics (e.g, electromagnetic interference (EMI) requirements, specific absorption rate (SAR) requirements, etc.), bill of materials (BOM) restrictions, and/or form factor constraints, among other things. It is to be noted that, “self-resonating frequency,” as known to those having skill in the art, generally refers to the resonant frequency of a passive component (e.g., an inductor) due to the parasitic characteristics of the component.

Antenna operating frequencies may comprise relatively high operating frequency ranges, examples of which may include, but are not limited to, 6.78 MHz (e.g., in accordance with the Rezence and/or Airfuel interface standard and/or any other proprietary interface operating at a frequency of 6.78 MHz), 13.56 MHz (e.g., in accordance with the NFC standard, defined by ISO/IEC standard 18092), 27 MHz, and/or an operating frequency of another proprietary operating mode. Such operating frequencies of the antennas may be operating frequencies designated by the International Telecommunications Union (ITU) in the Industrial, Scientific, and Medical (ISM) frequency bands, which may include the aforementioned 6.78 MHz, 13.56 MHz, and 27 MHz frequency bands, which are designated for use in wireless power transfer.

When such systems are operating to wirelessly transfer power from a transmission system to a receiver system via the antennas, it is often desired to simultaneously and/or at a different time communicate electronic data between the systems. In some example systems, wireless-power-related communications (e.g., validation procedures, electronic characteristics data, voltage data, current data, device type data, among other contemplated data communications related to wireless power transfer) are performed using in-band communications.

However, it is certainly possible that the connection of devices, via NFMI, may be utilized in transferring data, over the coupled antennas, that is not related to the instant wireless power transfer. Such data transfer may utilize the NFMI connection as a “pass through” or other data connection medium, for transferring data to/from a device operatively associated with the wireless receiver system.

In-band communications may be communications signals that are encoded in a carrier signal, wherein the carrier signal is generated via NFMI between two or more coupled antennas. In-band communications, as utilized by NFMI systems, are communication signals that are encoded into the induced signal between antennas that are coupled via NFMI. In some examples, in-band communications signals are encoded by modulating a carrier signal (e.g. a wireless power signal or a polling signal) between coupled transmitter and receiver antennas, by a system selectively damping the induced signal. Either the transmitting or receiving system of an NFMI coupled pair may selectively damp the signal, to encode the in-band signals.

In some examples, in-band communication signals in an NFMI system are encoded as amplitude shift keyed (ASK) signals, which, in some examples, may include on-off-keyed (OOK) signals, which are a subset of ASK signals. In an ASK signal, the wireless data signals are encoded by damping the voltage of the magnetic field between a wireless transmission system and a wireless receiver system. Such damping and subsequent re-rising of the voltage in the field is performed based on an underlying encoding scheme for the wireless data signals (e.g., binary coding, Manchester coding, pulse-width modulated coding, among other known or future-developed coding systems and methods). The receiver of the wireless data signals (e.g., a wireless transmission system in this example) can then detect rising and falling edges of the voltage of the induced field and decode said rising and falling edges to demodulate the wireless data signals.

Sensitive demodulation circuits that allow for fast and accurate in-band communications, regardless of the relative positions of the sender and receiver within the power transfer range, are desired. The demodulation circuit of the wireless power transmitters disclosed herein is a circuit that is utilized to, at least in part, decode or demodulate ASK (amplitude shift keying) signals down to alerts for rising and falling edges of a data signal. So long as the controller is programmed to properly process the coding schema of the ASK modulation, the transmission controller will expend less computational resources than it would if it were required to decode the leading and falling edges directly from an input current or voltage sense signal from the sensing system. To that end, the computational resources required by the transmission controller to decode the wireless data signals are significantly decreased due to the inclusion of the demodulation circuit.

This may in turn significantly reduce the BOM for the demodulation circuit, and the wireless transmission system as a whole, by allowing usage of cheaper, less computationally capable processor(s) for or with the transmission controller.

However, the throughput and accuracy of an edge-detection coding scheme depends in large part upon the system's ability to quickly and accurately detect signal slope changes. Moreover, in environments wherein the distance between, and orientations of, the sender and receiver may change dynamically, the magnitude of the received power signal and embedded data signal may also change dynamically. This circumstance may cause a previously readable signal to become too faint to discern, or may cause a previously readable signal to become saturated.

Achieving accurate and consistent communications is a particularly present issue, when a wireless power transfer system aims to operate over a large charge area, particularly those wherein the wireless receiver system may be in motion, with respect to a static wireless transmission system, during wireless power transfer operations.

To that end, disclosed are advancements in communications between wireless power transmission systems and wireless power receiver systems that leverage a period-based timing scheme that can be best accurately encoded/decoded by either the wireless transmission system or the wireless receiver system. The disclosed systems utilize the disclosed slope detector circuitry, on either the wireless transmission system or the wireless receiver system, to detect leading and falling edges of an ASK signal, which is then decoded from the period-based decoding scheme, by a controller, as data.

In some example wireless power transfer systems, wireless power transfer operations are desired over a substantially uniform area. Further still, in some example wireless power transfer systems, wireless power transfer operations, having enhanced uniformity over a large charge area, are desired. Such systems may be particularly advantageous in wireless charging scenarios where the power receiver or device associated with the power receiver is regularly moving or in motion, during a charge cycle.

A charge area may be an area associated with and proximate to a wireless power transmission system and, within said area, a wireless power receiver system is capable of coupling with the transmission system at a plurality of points within the charge area. To that end, it is advantageous, both for functionality and user experience, that the plurality of points for coupling within a charge area include as many points as possible and with as much of a consistent ability to couple with a receiver system, within the given charge area.

It is advantageous for large area power transmitters to be designed with maximum uniformity of power transmission in mind. Thus, it may be advantageous to design such transmission antennas with uniformity ratio in mind. Uniformity ratio may be the ratio of a maximum coupling, between a wireless transmission system and wireless receiver system, to a minimum coupling between said systems, wherein said coupling values are determined by measuring or determining a coupling between the systems at a plurality of points at which the wireless receiver system and/or antenna are placed within the charge area of the transmission antenna.

Further, while uniformity ratio can be enhanced by using more turns, coils, and/or other resonant bodies within an antenna, doing so increases the amount of conductive metals to maximize uniformity ratio and may give rise to cost concerns, bill of material concerns, environmental concerns, and/or sustainability concerns, among other known drawbacks from inclusion of more conductive materials. To that end, the following transmission antennas may be designed by balancing uniformity ratio considerations with cost, environmental, and/or sustainability considerations. In other words, the disclosed transmission antennas may be configured to achieve an increased (e.g., maximized) uniformity ratio, while reducing (e.g., minimizing) the use or the length of conductive wires and/or traces.

Large area power transmission systems may further be configured to have maximal metal resiliency. “Metal resiliency,” may be the ability of a transmission antenna and/or a wireless transmission system, itself, to avoid degradation in wireless power transfer performance when a metal or metallic material is present in an environment wherein the wireless transmission system operates. For example, metal resiliency may refer to the ability of wireless transmission system to maintain its inductance for power transfer, when a metallic body is present proximate to the transmission antenna. Additionally or alternatively, eddy currents generated by a metal body's presence proximate to the transmission system may degrade performance in wireless power transfer and, thus, induction of such currents are to be avoided.

Large charge area antennas may utilize internal repeaters for expanding charge area. An “internal repeater” may refer to a repeater coil or antenna that is utilized as part of a common antenna for a system, rather than as a repeater outside the bounds of such an antenna (e.g., a peripheral antenna for extending a signal outside the bounds of a transmission antenna's charge area). For example, a user of the wireless power transmission system would not know the difference between a system with an internal repeater and one in which all coils are wired to the transmitter electrical components, so long as both systems are housed in an opaque mechanical housing. Internal repeaters may be beneficial for use in unitary wireless transmission antennas because they allow for longer wires for coils, without introducing the high levels of electromagnetic interference (EMI) that are associated with longer wires connected to a common wired signal source. Additionally or alternatively, use of internal repeaters may be beneficial in improving metal resiliency and/or uniformity ratio for the wireless transmission antenna(s).

Some antennas with internal repeaters may be configured with alternating current directions of inner and outer turns. Thus, as one views the antenna both from left-to-right and from top-to-bottom, the current direction reverses from turn to turn. By reversing current directions from turn-to-turn both laterally (side to side) and from top-to-bottom, optimal field uniformity may be maintained. By reversing current directions amongst inner and outer turns, both laterally and top-to-bottom, a receiver antenna travelling across the charge area of the antenna will more often be positioned more closer-to-perpendicular with the magnetic field emanating from the antenna. Thus, as a receiver antenna will best couple with the transmission antenna at points of perpendicularity with the magnetic field, the charge area generated by the antenna will have greater uniformity than if all of the turns carried the current in a common direction.

Further still, in a wide area wireless power transfer system, given the wide range of coupling and associated current and/or voltage levels associated therewith, stability is imperative for consistent, accurate, and efficient use of the system. Stability is desired over any possible coupling that occurs, in use, between a wireless transmission system and a wireless receiver system of such a wireless power transfer system. Additionally, if said system is configured to operate while a wireless receiver system is moving, relative to the wireless transmission system and while remaining coupled, then the coupling may change, in large or small degrees, during use.

Due to the wide range of couplings possible when utilizing large area wireless transmission systems and the possibility that movement of the wireless receiver system alters the coupling within said range of couplings, the electrical properties of the NFMI connection between coupled wireless transmission and receiver systems may change often, during use, based on the coupling and changes thereof. For example, assuming that a voltage associated with a coupled pair of wireless transmission and receiver systems remains substantially consistent, if the coupling changes, then the current drawn, from an input power source by the wireless transmission system, may be altered due to the change in impedance that is associated with a change in coupling. For example, if coupling between a pair of wireless transmission and receiver systems changes from a first coupling to a second coupling, at a relatively consistent voltage, and the second coupling is less than the first coupling, then the wireless transmission system may attempt to draw more current from an input power source to achieve power demands of the wireless receiver system, as the lower coupling imposes a greater impedance on the wireless transfer system, as a whole.

In view of the aforementioned example, consider a large area wireless transmission system that receives input power via a universal serial bus (USB) Type-A (USB-A) input, which has an output current limit of about 500 milliamps (mA) and the overall wireless transmission is configured for wireless power transfer at a relatively consistent voltage of about 5 volts (V). In such an example, if the coupling changes such that the transfer impedance, due to the coupling, is altered in such a drastic fashion that the requested input current by the wireless transmission system rises above 500 mA, then errors or operational instability may occur over the entire wireless transfer system. To that end, it may be advantageous to mitigate the effects of this impedance shift to ensure that an input current to the system does not exceed the limits imposed by the input power source (e.g., a USB-A input power source).

Thus, as disclosed herein, input power stabilization systems may be utilized for wide area wireless power transfer systems to mitigate unnecessary stability issues that arise from alterations in coupling between pairs of wireless transmission and receiver systems. Accordingly, such an input power stabilization system may provide a passive component-based control loop that stabilizes the input current to a system, during all phases of use of the wide area wireless power transfer system.

To that end, the systems and methods disclosed herein provide for wireless power transfer systems that enhance system operation stability. For example, the systems and methods disclosed herein may provide for wireless power transfer systems with enhanced stability in communications between wireless receiver system(s) and wireless transmission system(s). Further still, the systems and methods disclosed herein may provide for wireless power transmission systems with improved input power stability.

In the following description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. For example, as noted above, an NFMI system operating at an operating frequency of about 6.78 MHz is used herein as an example for a NFMI power and/or data system. However, other wired and wireless communications techniques may be used while embodying the principles of the present disclosure.

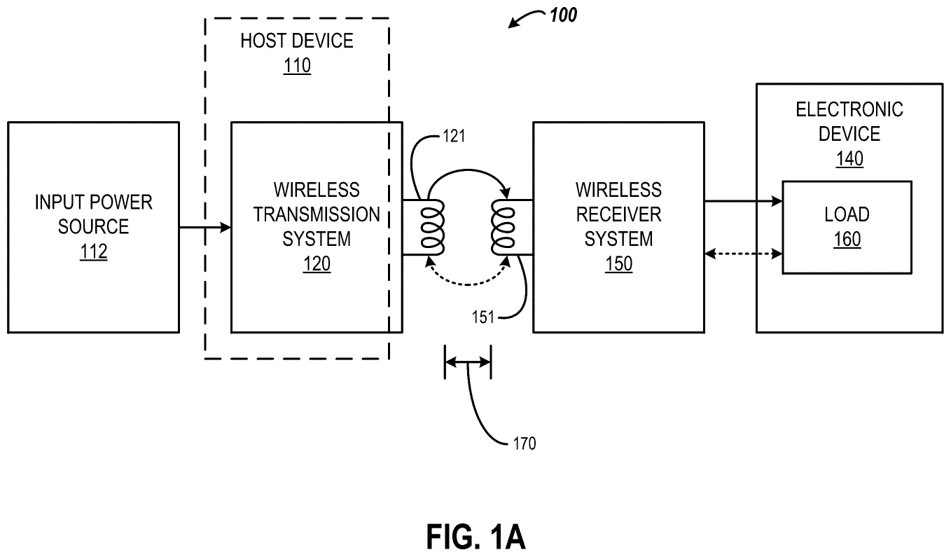

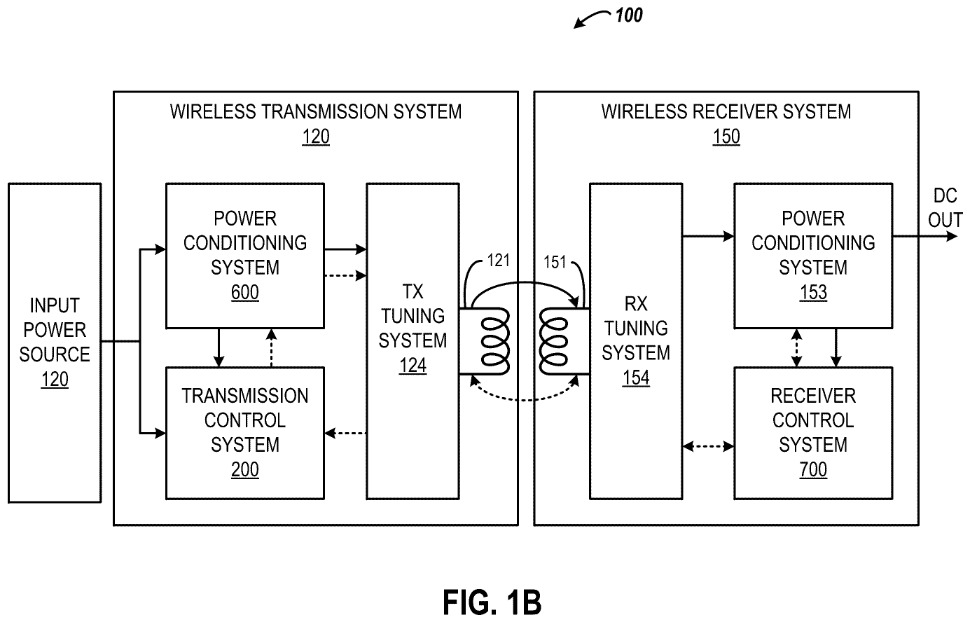

Referring now to the drawings and with specific reference to FIG. 1, a wireless power transfer system 100 is illustrated. The wireless power transfer system 100 provides for the wireless transmission of electrical signals, such as, but not limited to, electrical energy, electrical power, electrical power signals, electromagnetic energy, and electronically transmittable data (“electronic data”). As used herein, the term “electrical power signal” refers to an electrical signal transmitted specifically to provide meaningful electrical energy for charging and/or directly powering a load, whereas the term “electronic data signal” refers to an electrical signal that is utilized to convey data across a medium.

The wireless power transfer system 100 provides for the wireless transmission of electrical signals via NFMI. As shown in the embodiment of FIG. 1A, the wireless power transfer system 100 includes a wireless transmission system 120 and a wireless receiver system 130. The wireless receiver system is configured to receive electrical signals, via a receiver antenna 151, from a transmission antenna 121 of the wireless transmission system 120.

As illustrated, the wireless transmission system 120 and wireless receiver system 130 may be configured to transmit electrical signals across, at least, a separation distance or gap 170. A separation distance or gap, such as the gap 170, in the context of a wireless power transfer system, such as the system 100, does not include a physical connection, such as a wired connection. There may be intermediary objects located in a separation distance or gap, such as, but not limited to, air, a counter top, a casing for an electronic device, a plastic filament, an insulator, a mechanical wall, among other things; however, there is no physical, electrical connection at such a separation distance or gap.

Thus, the combination of the wireless transmission system 120 and the wireless receiver system 130 creates an electrical connection without the need for a physical connection. As referenced herein, the term “electrical connection” refers to any facilitation of a transfer of an electrical current, voltage, and/or power from a first location, device, component, and/or source to a second location, device, component, and/or destination. An “electrical connection” may be a physical connection, such as, but not limited to, a wire, a trace, a via, among other physical electrical connections, connecting a first location, device, component, and/or source to a second location, device, component, and/or destination. Additionally or alternatively, an “electrical connection” may be a wireless power and/or data transfer, such as, but not limited to, magnetic, electromagnetic, resonant, and/or inductive field, among other wireless power and/or data transfers, connecting a first location, device, component, and/or source to a second location, device, component, and/or destination.

In some cases, the gap 170 may also be referenced as a “Z-Distance,” because, if one considers an antenna 121, 151 each to be disposed substantially along respective common X-Y planes, then the distance separating the antennas 121, 151 is the gap in a “Z” or “depth” direction. However, flexible and/or non-planar coils are certainly contemplated by embodiments of the present disclosure and, thus, it is contemplated that the gap 170 may not be uniform, across an envelope of connection distances between the antennas 121, 151. It is contemplated that various tunings, configurations, and/or other parameters may alter the possible maximum distance of the gap 170, such that electrical transmission from the wireless transmission system 120 to the wireless receiver system 130 remains possible.

The wireless power transfer system 100 operates when the wireless transmission system 120 and the wireless receiver system 130 are coupled. As used herein, the terms “couples,” “coupled,” and “coupling” generally refer to magnetic field coupling, which occurs when a transmitter and/or any components thereof and a receiver and/or any components thereof are coupled to each other through a magnetic field. Such coupling may include coupling, represented by a coupling coefficient (k), that is at least sufficient for an induced electrical power signal, from a transmitter, to be harnessed by a receiver. Coupling of the wireless transmission system 120 and the wireless receiver system 130, in the system 100, may be represented by a resonant coupling coefficient of the system 100 and, for the purposes of wireless power transfer, the coupling coefficient for the system 100 may be in the range of about 0.01 to about 0.9.

As illustrated, the wireless transmission system 120 may be associated with a host device 110, which may receive power from an input power source 112. The host device 110 may be any electrically operated device, circuit board, electronic assembly, dedicated charging device, or any other contemplated electronic device. Example host devices 110, with which the wireless transmission system 120 may be associated therewith, include, but are not limited to including, a device that includes an integrated circuit, cases for wearable electronic devices, receptacles for electronic devices, a portable computing device, wearable charging devices, on-device chargers, clothing configured with electronics, storage medium for electronic devices, charging apparatus for one or multiple electronic devices, dedicated electrical charging devices, activity or sport related equipment, goods, and/or data collection devices, among other contemplated electronic devices.

As illustrated, one or both of the wireless transmission system 120 and the host device 110 are operatively associated with an input power source 112. The input power source 112 may be or may include one or more electrical storage devices, such as an electrochemical cell, a battery pack, and/or a capacitor, among other storage devices. Additionally or alternatively, the input power source 112 may be any electrical input source (e.g., any alternating current (AC) or direct current (DC) delivery port) and may include connection apparatus from said electrical input source to the wireless transmission system 120 (e.g., transformers, regulators, conductive conduits, traces, wires, equipment, computer, camera, mobile phone, and/or other electrical device connection ports and/or adaptors, such as but not limited to USB ports and/or adaptors, among other contemplated electrical components).

Electrical energy received by the wireless transmission system 120 is then used for at least two purposes: to provide electrical power to internal components of the wireless transmission system 120 and to provide electrical power to the transmission antenna 121. The transmission antenna 121 is configured to wirelessly transmit the electrical signals conditioned and modified for wireless transmission by the wireless transmission system 120 via NFMI.

The transmission antenna 121 and the receiver antenna 151 of the present disclosure may be configured to transmit and/or receive electrical power having a magnitude that ranges from about 10 milliwatts (mW) to about 500 watts (W). In one or more embodiments the inductor coil of the transmission antenna 121 is configured to resonate at a transmitting antenna resonant frequency or within a transmitting antenna resonant frequency band.

As known to those skilled in the art, a “resonant frequency” or “resonant frequency band” refers a frequency or frequencies wherein amplitude response of the antenna is at a relative maximum, or, additionally or alternatively, the frequency or frequency band where the capacitive reactance has a magnitude substantially similar to the magnitude of the inductive reactance. In one or more embodiments, the transmitting antenna resonant frequency is at a high frequency, as known to those in the art of wireless power transfer.

The wireless receiver system 130 may be associated with an example electronic device 140, wherein the electronic device 140 may be any device that requires electrical power for any function and/or for power storage (e.g., via a battery and/or capacitor). Additionally, the electronic device 140 may be any device capable of receipt of electronically transmissible data. For example, the device may be, but is not limited to being, a handheld computing device, a mobile device, a portable appliance, a computer peripheral, an integrated circuit, an identifiable tag, a kitchen utility device, an electronic tool, an electric vehicle, a game console, a robotic device, a wearable electronic device (e.g., an electronic watch, a fitness tracker, electronically modified glasses, altered-reality (AR) glasses, virtual reality (VR) glasses, among other things), a portable scanning device, a portable identifying device, a sporting good, an embedded sensor, an Internet of Things (IoT) sensor, IoT enabled clothing, IoT enabled recreational equipment, industrial equipment, medical equipment, a medical device, a tablet computing device, a portable control device, a remote controller for an electronic device, a gaming controller, among other things.

For the purposes of illustrating the features and characteristics of the disclosed embodiments, arrow-ended lines are utilized to illustrate transferrable and/or communicative signals and various patterns are used to illustrate electrical signals that are intended for power transmission and electrical signals that are intended for the transmission of data and/or control instructions. Solid lines indicate signal transmission of electrical energy over a physical and/or wireless power transfer, in the form of power signals that are, ultimately, utilized in wireless power transmission from the wireless transmission system 120 to the wireless receiver system 130. Further, dotted lines are utilized to illustrate electronically transmittable data signals, which ultimately may be wirelessly transmitted from the wireless transmission system 120 to the wireless receiver system 130.

While the systems and methods herein illustrate the transmission of wirelessly transmitted energy, wireless power signals, wirelessly transmitted power, wirelessly transmitted electromagnetic energy, and/or electronically transmittable data, it is certainly contemplated that the systems, methods, and apparatus disclosed herein may be utilized in the transmission of only one signal, various combinations of two signals, or more than two signals and, further, it is contemplated that the systems, method, and apparatus disclosed herein may be utilized for wireless transmission of other electrical signals in addition to or uniquely in combination with one or more of the above mentioned signals. In some examples, the signal paths of solid or dotted lines may represent a functional signal path, whereas, in practical application, the actual signal is routed through additional components en route to its indicated destination. For example, it may be indicated that a data signal routes from a communications apparatus to another communications apparatus; however, in practical application, the data signal may be routed through an amplifier, then through a transmission antenna, to a receiver antenna, where, on the receiver end, the data signal is decoded by a respective communications device of the receiver.

Turning now to FIG. 1B, the wireless connection system 100 is illustrated as a block diagram including example sub-systems of both the wireless transmission system 120 and the wireless receiver system 130. The wireless transmission system 120 may include, at least, a power conditioning system 600, a transmission control system 200, a transmission tuning system 124, and the transmission antenna 121. A first portion of the electrical energy input from the input power source 112 is configured to electrically power components of the wireless transmission system 120 such as, but not limited to, the transmission control system 200. A second portion of the electrical energy input from the input power source 112 is conditioned and/or modified for wireless power transmission, to the wireless receiver system 130, via the transmission antenna 121. Accordingly, the second portion of the input energy is modified and/or conditioned by the power conditioning system 600. While not illustrated, it is certainly contemplated that one or both of the first and second portions of the input electrical energy may be modified, conditioned, altered, and/or otherwise changed prior to receipt by the power conditioning system 600 and/or transmission control system 200, by further contemplated subsystems (e.g., a voltage regulator, a current regulator, switching systems, fault systems, safety regulators, among other things).

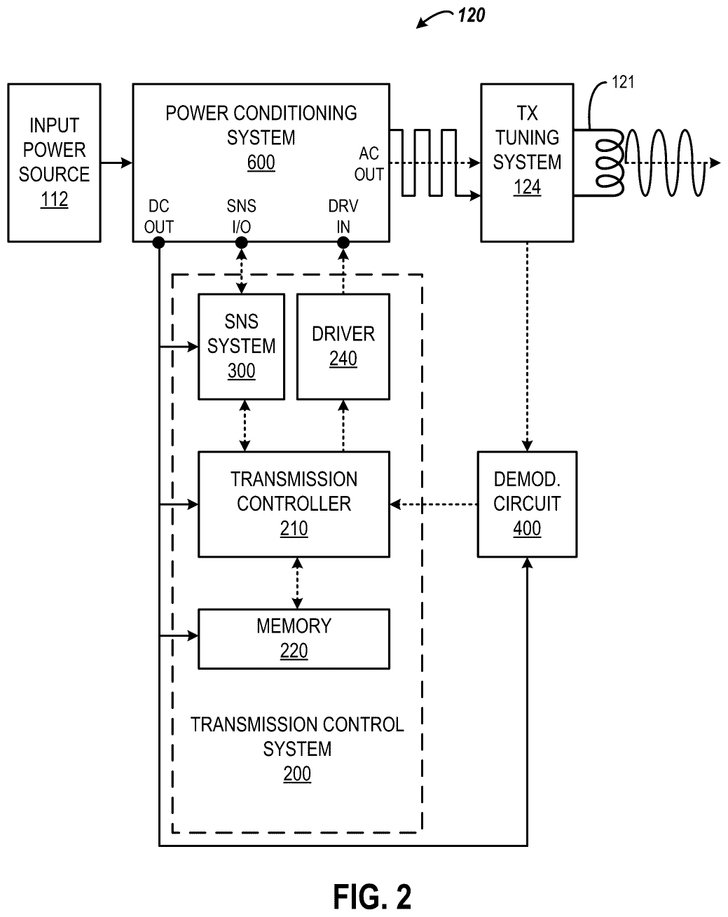

Referring now to FIG. 2, with continued reference to FIGS. 1A and 1B, subcomponents and/or systems of the transmission control system 200 are illustrated. The transmission control system 200 may include a sensing system 300, a transmission controller 210, a driver 240, and a memory 220.

The transmission controller 210 may be any electronic controller or computing system that includes, at least, a processor which performs operations, executes control algorithms, stores data, retrieves data, gathers data, controls and/or provides communication with other components and/or subsystems associated with the wireless transmission system 120, and/or performs any other computing or controlling task desired. The transmission controller 210 includes at least one processor, at least one machine-readable medium, and program instructions stored on the at least one machine-readable medium which, when executed by the at least one processor, cause the transmission controller 210 to perform any of the functions disclosed herein.

The transmission controller 210 may be a single controller or may include more than one controller disposed to control various functions and/or features of the wireless transmission system 120. Functionality of the transmission controller 210 may be implemented in hardware and/or software and may rely on one or more data maps relating to the operation of the wireless transmission system 120.

To that end, the transmission controller 210 may be operatively associated with the memory 220. The memory may include one or more of internal memory, external memory, and/or remote memory (e.g., a database and/or server operatively connected to the transmission controller 28 via a network, such as, but not limited to, the Internet), each of which may be examples of at least one non-transitory machine-readable medium. The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), graphics double data rate synchronous dynamic RAM (GDDR SDRAM, GDDR2, GDDR3, GDDR4, GDDR5, GDDR6), a flash memory, a portable memory, and the like. Such memory media are examples of non-transitory machine-readable and/or computer-readable memory media.

While particular elements of the transmission control system 200 are illustrated as independent components and/or circuits (e.g., the driver 240, the memory 220, the sensing system 300, among other contemplated elements) of the transmission control system 200, such components may be integrated with the transmission controller 210. In some examples, the transmission controller 210 may be an integrated circuit configured to include functional elements of one or more of the transmission controller 210 and/or other components of the wireless transmission system 120, generally.

Prior to providing data transmission and receipt details, it should be noted that either of the wireless transmission system 120 and the wireless receiver system 130 may send data to the other within the disclosed principles, regardless of which entity is wirelessly sending or wirelessly receiving power. As illustrated, the transmission controller 210 is in operative association, for the purposes of data transmission, receipt, and/or communication, with, at least, the memory 220, a demodulation circuit 400, the power conditioning system 600, the driver 240, and the sensing system 300.

The driver 240 may be implemented to control, at least in part, the operation of the power conditioning system 600. In some examples, the driver 240 may receive instructions from the transmission controller 210 to generate and/or output a generated pulse width modulation (PWM) signal to the power conditioning system 600. In some such examples, the PWM signal may be configured to drive the power conditioning system 600 to output electrical power as an alternating current signal, having an operating frequency defined by the PWM signal. In some examples, PWM signal may be configured to generate a duty cycle for the AC power signal output by the power conditioning system 600. In some such examples, the duty cycle may be configured to be about 50% of a given period of the AC power signal; however, the duty cycle is certainly not limited to being about 50% of a given period of the AC power signal.

The sensing system 300 may include one or more sensors, wherein each sensor may be operatively associated with one or more components of the wireless transmission system 120 and configured to provide information and/or data. The term “sensor” is used in its broadest interpretation to define one or more components operatively associated with the wireless transmission system 120 that operate to sense functions, conditions, electrical characteristics, operations, and/or operating characteristics of one or more of the wireless transmission system 120, the wireless receiving system 130, the input power source 112, the host device 110, the transmission antenna 121, the receiver antenna 151, along with any other components and/or subcomponents thereof. Again, while the examples may illustrate a certain configuration, it should be appreciated that either of the wireless transmission system 120 and the wireless receiver system 130 may send data to the other within the disclosed principles, regardless of which entity is wirelessly sending or wirelessly receiving power.

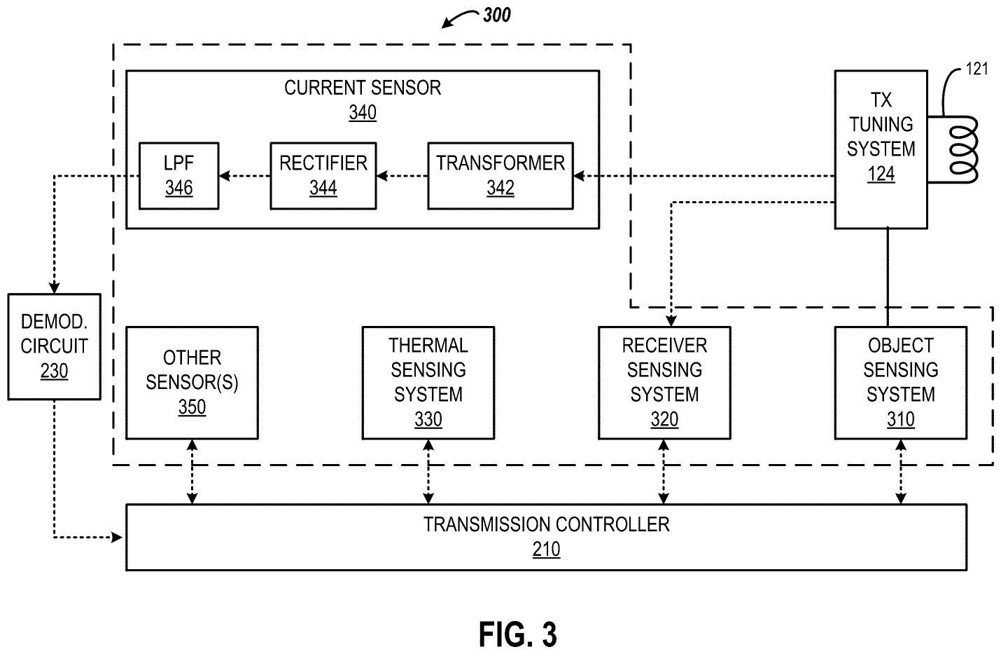

As illustrated in the embodiment of FIG. 3, the sensing system 300 may include, but is not limited to including, a thermal sensing system 330, an object sensing system 310, a receiver sensing system 320, a current sensor 340, and/or any other sensor(s) 350. Within these systems, there may exist even more specific optional additional or alternative sensing systems addressing particular sensing aspects required by an application, such as, but not limited to: a condition-based maintenance sensing system, a performance optimization sensing system, a state-of-charge sensing system, a temperature management sensing system, a component heating sensing system, an IoT sensing system, an energy and/or power management sensing system, an impact detection sensing system, an electrical status sensing system, a speed detection sensing system, a device health sensing system, among others. The object sensing system 310, may be a foreign object detection (FOD) system. The sensing system 300 may include other sensing components, as well.

Each of the thermal sensing system 330, the object sensing system 310, the receiver sensing system 320 and/or the other sensor(s) 350, including the optional additional or alternative systems, are operatively and/or communicatively connected to the transmission controller 210. The thermal sensing system 330 is configured to monitor ambient and/or component temperatures within the wireless transmission system 120 or other elements nearby the wireless transmission system 120. The thermal sensing system 330 may be configured to detect a temperature within the wireless transmission system 120 and, if the detected temperature exceeds a threshold temperature, the transmission controller 210 prevents the wireless transmission system 120 from operating. Such a threshold temperature may be configured for safety considerations, operational considerations, efficiency considerations, and/or any combinations thereof. In a non-limiting example, if, via input from the thermal sensing system 330, the transmission controller 210 determines that the temperature within the wireless transmission system 120 has increased from an acceptable operating temperature to an undesired operating temperature (e.g., in a non-limiting example, the internal temperature increasing from about 20° Celsius (C) to about 50° C., the transmission controller 210 prevents the operation of the wireless transmission system 120 and/or reduces levels of power output from the wireless transmission system 120. In some non-limiting examples, the thermal sensing system 330 may include one or more of a thermocouple, a thermistor, a negative temperature coefficient (NTC) resistor, a resistance temperature detector (RTD), and/or any combinations thereof.

As depicted in FIG. 3, the sensing system 300 may include the object sensing system 310. The object sensing system 310 may be configured to detect one or more of the wireless receiver system 130 and/or the receiver antenna 151, thus indicating to the transmission controller 210 that the wireless receiver system 130 is proximate to the wireless transmission system 120. Additionally or alternatively, the object sensing system 310 may be configured to detect presence of unwanted objects in contact with or proximate to the wireless transmission system 120. In some examples, the object sensing system 310 is configured to detect the presence of an undesired object. In some such examples, if the transmission controller 210, via information provided by the object sensing system 310, detects the presence of an undesired object, then the transmission controller 210 prevents or otherwise modifies operation of the wireless transmission system 20. In some examples, the object sensing system 310 utilizes an impedance change detection scheme, in which the transmission controller 210 analyzes a change in electrical impedance observed by the transmission antenna 121 against a known, acceptable electrical impedance value or range of electrical impedance values.

Additionally or alternatively, the object sensing system 310 may utilize a quality factor (Q) change detection scheme, in which the transmission controller 210 analyzes a change from a known quality factor value or range of quality factor values of the object being detected, such as the receiver antenna 151. The “quality factor” or “Q” of an inductor can be defined as (frequency (Hz)×inductance (H))/resistance (ohms), where frequency is the operational frequency of the circuit, inductance is the inductance output of the inductor and resistance is the combination of the radiative and reactive resistances that are internal to the inductor. “Quality factor,” as defined herein, is generally accepted as an index (figure of measure) that measures the efficiency of an apparatus like an antenna, a circuit, or a resonator. In some examples, the object sensing system 310 may include one or more of an optical sensor, an electro-optical sensor, a Hall effect sensor, a proximity sensor, and/or any combinations thereof.

The receiver sensing system 320 is any sensor, circuit, and/or combinations thereof configured to detect presence of any wireless receiving system that may be couplable with the wireless transmission system 120. In some examples, the receiver sensing system 320 and the object sensing system 310 may be combined, may share components, and/or may be embodied by one or more common components. In some examples, if the presence of any such wireless receiving system is detected, wireless transmission of electrical energy, electrical power, electromagnetic energy, and/or data by the wireless transmission system 120 to said wireless receiving system is enabled. In some examples, if the presence of a wireless receiver system is not detected, continued wireless transmission of electrical energy, electrical power, electromagnetic energy, and/or data is prevented from occurring. Accordingly, the receiver sensing system 320 may include one or more sensors and/or may be operatively associated with one or more sensors that are configured to analyze electrical characteristics within an environment of or proximate to the wireless transmission system 120 and, based on the electrical characteristics, determine presence of a wireless receiver system 130.

The current sensor 340 may be any sensor configured to determine electrical information from an electrical signal, such as a voltage or a current, based on a current reading at the current sensor 340. Components of an example current sensor 340 are further illustrated in FIG. 3, which includes a block diagram for sub-components of the current sensor 340. For example, the current sensor 340 may include a transformer 342, a rectifier 344, and/or a low pass filter 346, to process the AC wireless signals, transferred via coupling between the wireless receiver system 150 and wireless transmission system 120, to determine or provide information to derive a current (I_{Tx}/I_{Rx}) or voltage (V_{Tx}/V_{Rx}) at one or both of the antenna(s) 121, 151. The transformer 342 may receive the AC wireless signals and either step up or step down the voltage of the AC wireless signal, such that it can properly be processed by the current sensor 340. The rectifier 344 may receive the transformed AC wireless signal and rectify the signal, such that any negative voltages remaining in the transformed AC wireless signal are either eliminated or converted to opposite positive voltages, to generate a rectified AC wireless signal. The low pass filter 346 is configured to receive the rectified AC wireless signal and filter out AC components (e.g., the operating or carrier frequency of the AC wireless signal) of the rectified AC wireless signal, such that a DC voltage is output for the current (I_{Tx}/I_{Rx}) and/or voltage (V_{Tx}/V_{Rx}) at one or both of the antenna(s) 121, 151.

Of course, the current sensor 340 may take other forms, as well, including additional or alternative components for determining electrical characteristics of a signal.

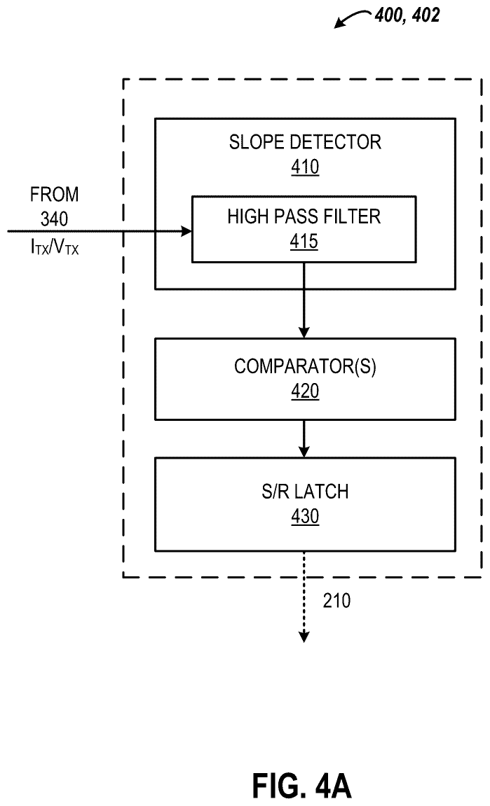

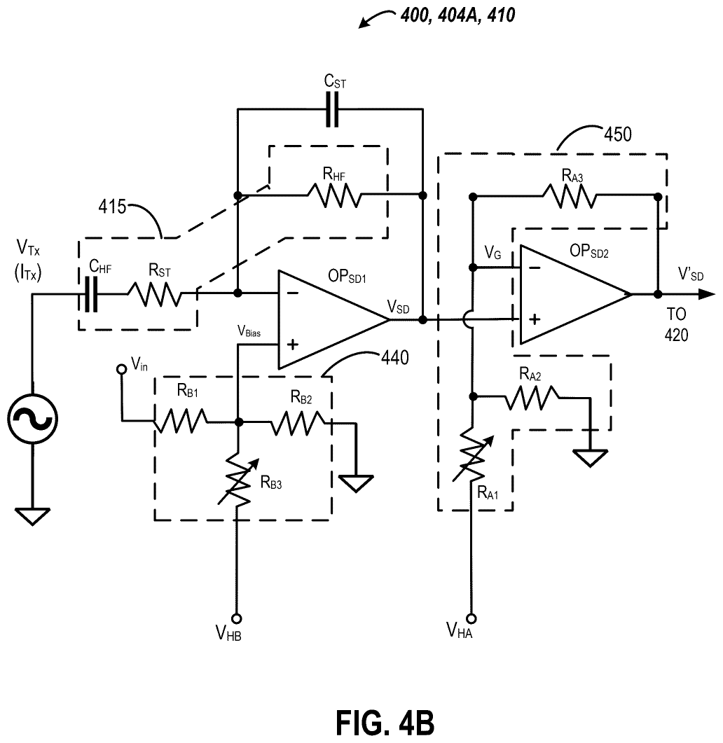

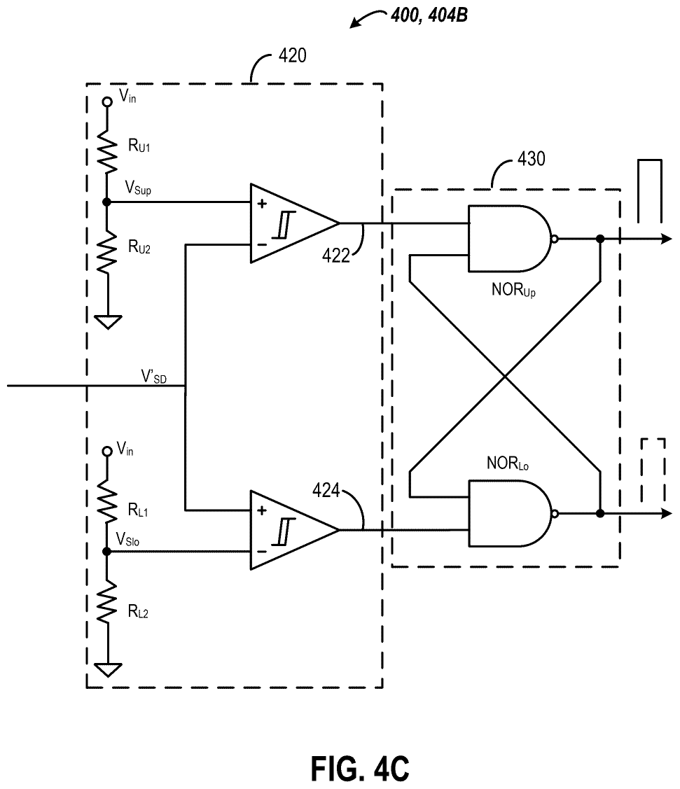

FIG. 4A is a block diagram 402 for the demodulation circuit 400 for the wireless transmission system 120, which is used by the wireless transmission system 120 to simplify or decode components of wireless data signals of an alternating current (AC) wireless signal, prior to receipt of the wireless data signal at the transmission controller 210. The demodulation circuit includes, at least, a slope detector 410 and a comparator circuit 420. In some examples, the demodulation circuit 400 includes a set/reset (S/R) latch 430.

In some examples, the demodulation circuit 400 may be an analog circuit comprised of one or more passive components (e.g., resistors, capacitors, inductors, diodes, among other passive components) and/or one or more active components (e.g., operational amplifiers, logic gates, among other active components). Alternatively, it is contemplated that the demodulation circuit 400 and some or all of its components may be implemented as an integrated circuit (IC). In either an analog circuit or IC, it is contemplated that the demodulation circuit 400 may be external of a controller (e.g., the transmission controller 210) and is configured to provide information associated with wireless data signals transmitted from one of the systems 120, 130 to the other system 120, 130.

The demodulation circuit 400 is configured to receive electrical information (e.g., I_{Tx}/I_{Rx}, V_{Tx}/V_{Rx}) from at least one sensor (e.g., the current sensor 340), detect a change in such electrical information, and determine if the change in the electrical information meets or exceeds one of a rise threshold or a fall threshold. If the change exceeds one of the rise threshold or the fall threshold, the demodulation circuit 400 generates an output signal and also generates and outputs one or more data alerts. Such data alerts are received by the transmission controller 210 and decoded by the transmission controller 210 to determine the wireless data signals.

In other words, in an embodiment, the demodulation circuit 400 is configured to monitor the slope of an electrical signal (e.g., slope of a voltage signal at the power conditioning system 600 of the wireless transmission system 120) and to output an indication when said slope exceeds a maximum slope threshold or undershoots a minimum slope threshold. Such slope monitoring and/or slope detection by the slope detector 410 is particularly useful when detecting or decoding an amplitude shift keying (ASK) signal that encodes the wireless data signals in-band of the wireless power signal (which is oscillating at the operating frequency).

In an ASK signal, as noted above, the wireless data signals are encoded by damping the voltage of the magnetic field between the wireless transmission system 120 and the wireless receiver system 130. Such damping and subsequent re-rising of the voltage in the field is performed based on an underlying encoding scheme for the wireless data signals (e.g., binary coding, Manchester coding, pulse-width modulated coding, among other known or novel coding systems and methods). The receiver of the wireless data signals (e.g., the wireless transmission system 120 in this example) can then detect rising and falling edges of the voltage of the field and decode said rising and falling edges to demodulate the wireless data signals.

Ideally, an ASK signal would rise and fall instantaneously, with no discernable slope between the high voltage and the low voltage for ASK modulation; however, in reality, there is a finite amount of time that passes when the ASK signal transitions from the “high” voltage to the “low” voltage and vice versa. Thus, the voltage or current signal to be sensed by the demodulation circuit 400 will have some slope or rate of change in voltage when transitioning. By configuring the demodulation circuit 70 to determine when said slope meets, overshoots and/or undershoots such rise and fall thresholds, established based on the known maximum/minimum slope of the carrier signal at the operating frequency, the demodulation circuit can accurately detect rising and falling edges of the ASK signal.

Thus, a relatively inexpensive and/or simplified circuit may be utilized to at least partially decode ASK signals down to notifications or alerts for rising and falling slope instances. As long as the transmission controller 210 is programmed to understand the coding schema of the ASK modulation, the transmission controller 210 will expend far less computational resources than would have been needed to decode the leading and falling edges directly from an input current or voltage sense signal from the current sensor 340. To that end, as the computational resources required by the transmission controller 210 to decode the wireless data signals are significantly decreased due to the inclusion of the demodulation circuit 400, the demodulation circuit 400 may significantly reduce BOM of the wireless transmission system 120, by allowing usage of cheaper, less computationally capable processor(s) for or with the transmission controller 210.

As noted above, slope detection, and hence in-band transfer of data, may become ineffective or inefficient when the signal strength varies from the parameters relied upon during design. For example, when the relative positions of the data sender and data receiver vary significantly during use of the system, the electromagnetic coupling between sender and receiver coils or antennas will also vary. Data detection and decoding are optimized for a particular coupling may fail or underperform at other couplings. As such, a high sensitivity non-saturating detection system is needed to allow the system to operate in environments wherein coupling changes dynamically.

For example, referring a first schematic portion 404A of a schematic representative of a circuit for the slope detector 410, as illustrated in FIG. 4B, the signal created by the high pass filter 415 of the slope detector 410, prior to being amplified by a first operational amplifier (OP_{SD1}), will vary as a result of varying coupling (as will the power signal, but, for the purposes of the discussion of in-band data, it has now been filtered out at this point). Thus, the difference in magnitude of the amplified signals will vary by even more. As illustrated, the high pass filter 415 may include a high pass filter capacitor (C_{HF}), a high pass filter resistor (R_{HF}), and, optionally, a stability resistor (R_{ST}). Values for C_{HF} and R_{HF} may be configured to filter the input signal at a given cutoff frequency defined via said values, while R_{ST} may be configured and included in the high pass filter 415 as a means for stabilizing signal throughout. Of course, the high pass filter 415 may take other forms and/or include additional or alternative components, as known by those having skill in the art.

At the upper end, substantially improved coupling may cause saturation of OP_{SD1}, at said upper end, if the system is tuned for small signal detection. Similarly, substantially degraded coupling may result in an undetectable signal if the system is tuned for high, good, and/or fair coupling. Moreover, a pre-amp signal with a positive offset may result in clipped (e.g., saturated) positive signals, post-amplification, unless gain is reduced; however, the reduced gain may in turn render negative signals undetectable. Additionally, a varying load at the wireless receiver system 130 may affect the signal, necessitating the amplification of the data signal at the slope detector 410, via, for example, utilization of OP_{SD1}.

As such, instability in coupling is generally not well-tolerated by inductive charging systems, since it causes the filtered and amplified signal to vary too greatly. For example, a phone placed into a fitted dock will stay in a specific location relative to the dock, and any coupling therebetween will remain relatively constant. However, a mobile phone placed on a desktop with an inductive charging station under the desktop may not maintain a fixed relative location, nor a fixed relative orientation and, thus, the range of coupling between the power transmitter and the receiver of the mobile phone may vary during the charging process.

Further, consider a wireless power system configured for directly powering and/or charging a medical device, while the medical device resides within a human body. Due to natural displacement and/or internal movement of organic elements of the human body, the medical device may not maintain constant location, relative to the body and/or an associated charger positioned outside of the body, and, thus, the transmitter and receiver may couple at a wide range of high, good, fair, low, and/or insufficient coupling levels.

Further still, consider a computer peripheral being charged by a charging mat on a user's desk. It may be desired to charge said peripheral, such as a mouse or other input device, during use of the device; such use of the peripheral will necessarily alter coupling during use, as it will be moved regularly, with respect to positioning of the transmitting charging mat.

Accordingly, in all of the aforementioned scenarios, amongst other wireless power transfer scenarios, a coupling coefficient “k,” representative of a coupling between systems 120, 130, may be variable during the transfer of power and/or data. The effect caused by a difference in the coupling coefficient k can be illustrated by a few non-limiting examples. Consider a case wherein k=0.041, representing fairly strong coupling. In this case, the induced voltage delta (V_{delta}) may be about 160 mV, with the corresponding amplified signal running between a peak of 3.15V and a nadir of 0.45V, for a swing of about 2.70V around a DC offset of 1.86V (i.e., 1.35V above and below the DC offset value).

Now consider a case in the same system wherein a coupling value of 0.01 is exhibited, representing fairly weak coupling. This weakening could happen due to relative movement, intervening materials, or other circumstance. Now V_{delta} may be about 15 mV, with the corresponding amplified signal running between a peak of 1.94V and a nadir of 1.77V, for a swing of about 140 mV around a DC offset of 1.86V (i.e., about 70 mV above and below the DC offset value).

As can be seen from this example, while the strongly coupled case yields robust signals, the weakly coupled case yields very small signals atop a fairly large offset. While perhaps generally detectable, these signal levels present a significant risk of data errors and consequently lowered throughput. Moreover, while there is room for increased amplification, the level of amplification, especially given the DC offset, is constrained by the saturation level of the available economical operational amplifier circuits, which, in some examples may be about 4.0V.

However, in an embodiment, automatic gain control in amplification is combined with a voltage offset in slope detection to allow the system to adapt to varying degrees of coupling. This is especially helpful in situations where the physical locations of the coupled devices are not tightly constrained during coupling.

Continuing with the example first schematic portion 404A of the demodulation circuit 400, including the slope detector 410, as illustrated in FIG. 4B, the bias voltage (V′_{Bias}) for slope detection is provided by a voltage divider 440 (including linked resistors R_{B1}, R_{B2}, R_{B3}), which provides a voltage between Vᵢₙ and ground based on a control voltage V_{HB}. Given the control voltage V_{HB}, the bias voltage V′_{Bias} is set by adjusting a resistance in the voltage divider. In this connection, at least one of the resistors (e.g., R_{B3}) may be a variable resistor, such as a digitally adjustable potentiometer, with the specific resistance, e.g., R_{bias} being generated via an adaptive bias and gain protocol to be described below.

Similarly, in the illustrated first schematic portion 404A, the output voltage V_{SD} provided to the next stage, the comparator circuit 420, is first amplified by a second operational amplifier OP_{SD2} at a level set by a second voltage divider 450 (including linked resistors R_{A1}, R_{A2}, R_{A3}), based on the control voltage V_{HA} to generate V′_{SD} (slope detection signal). The amplification of V_{SD} to generate V′_{SD} (amplified slope detection signal) is similarly set via a variable potentiometer in the voltage divider, e.g., R_{A1}, being set to a specific value, e.g., R_{gain} generated via an adaptive bias and gain protocol to be described later below.

With respect to the aforementioned, non-limiting example, with automatic gain and bias in slope detection, the circuit is configured to accommodate a V_{amp slope delta} of between 400 mv and 2.2V, and a V_{amp DC} offset of between 1.8V and 2.2V. In order to determine appropriate offsets and gains, the system may employ a beaconing sequence state. The beaconing sequence ensures that the transmitter is generally able to detect the receiver at all possible allowed coupling positions and orientations.

As discussed, the slope detector 410 includes the high pass filter 415 and an optional stabilizing resistor R_{ST}. The high pass filter 415 is configured to monitor for higher frequency components of the AC wireless signals and may include, at least, a filter capacitor (C_{HF}) and a filter resistor (R_{HF}). The values for C_{HF} and R_{HF} are selected and/or tuned for a desired cutoff frequency for the high pass filter 415. In some examples, the cutoff frequency for the high pass filter 415 may be selected as a value greater than or equal to about 1-2 kHz, to ensure adequately fast slope detection by the slope detector 410, when the operating frequency of the system 100 is on the order of MHz (e.g., an operating frequency of about 6.78 MHz). In some examples, the high pass filter 415 is configured such that harmonic components of the detected slope are unfiltered. In view of the current sensor 340 of FIG. 3, the high pass filter 415 and the low pass filter 346, in combination, may function as a bandpass filter for the demodulation circuit 400.

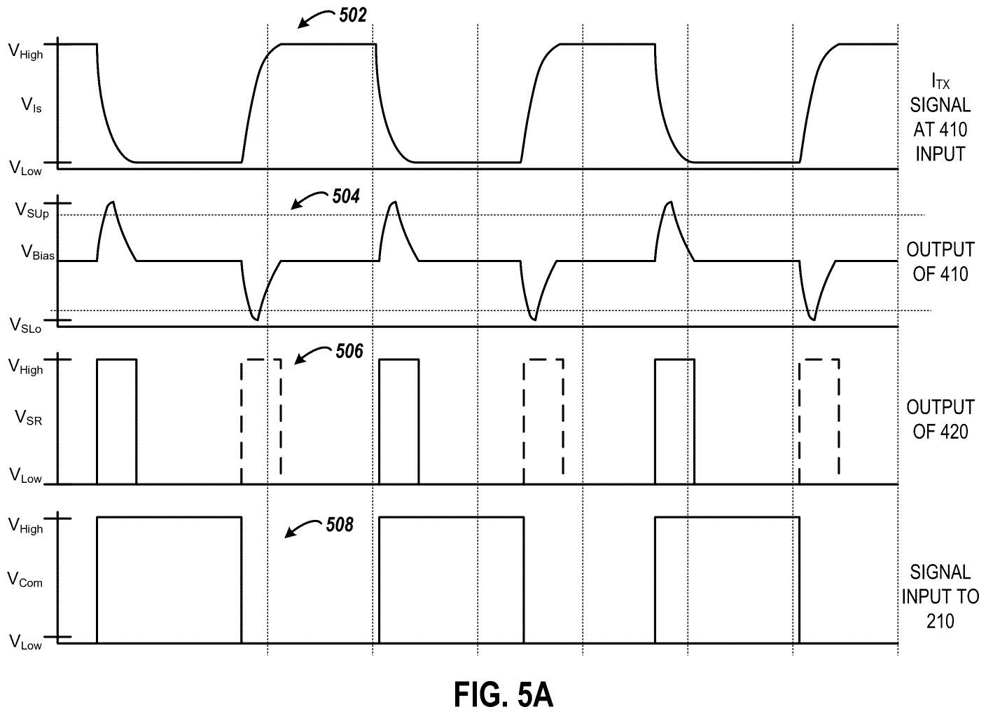

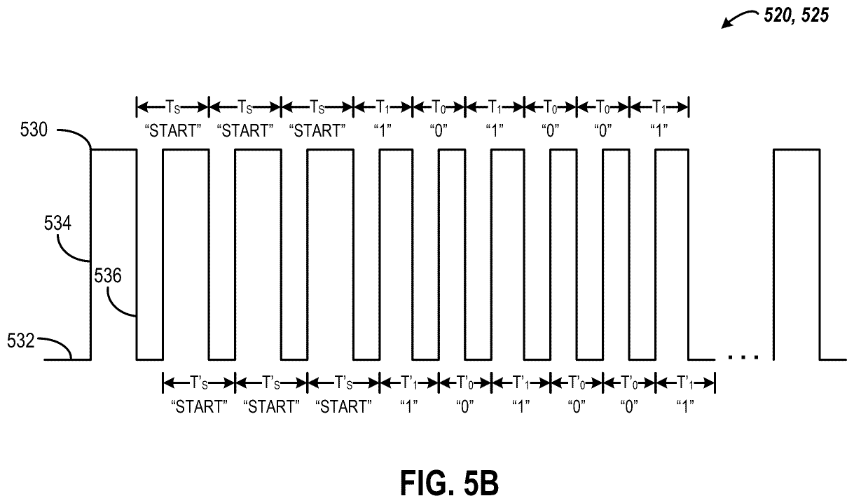

OP_{SD1} is any operational amplifier having an adequate bandwidth for proper signal response, for outputting the slope of V_{Tx}, but low enough to attenuate components of the signal that are based on the operating frequency and/or harmonics of the operating frequency. Additionally or alternatively, OP_{SD1} may be selected to have a small input voltage range for V_{Tx}, such that OP_{SD1} may avoid unnecessary error or clipping during large changes in voltage at V_{Tx}. Further, an input bias voltage (V_{Bias}) for OP_{SD1} may be selected based on values that ensure OP_{SD1} will not saturate under boundary conditions (e.g., steepest slopes, largest changes in V_{Tx}). It is to be noted, and is illustrated in Plot B of FIG. 5, that when no slope is detected, the output of the slope detector 410 will be V_{Bias}.

As the passive components of the slope detector 410 will set the terminals and zeroes for a transfer function of the slope detector 410, such passive components must be selected to ensure stability. To that end, if the desired and/or available components selected for C_{HF} and R_{HF} do not adequately set the terminals and zeros for the transfer function, additional, optional stability capacitor(s) C_{ST} may be placed in parallel with R_{HF} and stability resistor R_{ST} may be placed in the input path to OP_{SD}.

Output of the slope detector 410 (e.g., Plot B of FIG. 5, representing V_{SD}) may approximate the following equation:

$${V}_{SD} = - {R}_{HF} {C}_{HF} \frac{dV}{dt} + {V}_{Bias}$$

Thus, V_{SD} will approximate to V_{Bias}, when no change in voltage (slope) is detected, and utput V_{SD} of the slope detector 410 is represented in Plot B. As can be seen, the value of V_{SD} approximates V_{Bias} when no change in voltage (slope) is detected, whereas V_{SD} will output the change in voltage (dV/dt), as scaled by the high pass filter 415, when V_{Tx} rises and falls between the high voltage and the low voltage of the ASK modulation. The output of the slope detector 410, as illustrated in Plot B, may be a pulse, showing slope of V_{Tx} rise and fall.

As best illustrated in the second schematic portion 404B of the demodulation circuit 400, V′_{SD} is output to the comparator circuit(s) 420, which is configured to receive V′_{SD}, compare V′_{SD} to a rising rate of change for the voltage (V_{SUp}) and a falling rate of change for the voltage (V_{SLo}). If V_{SD} exceeds or meets V_{SUp}, then the comparator circuit will determine that the change in V_{Tx} meets the rise threshold and indicates a rising edge in the ASK modulation. If V′_{SD} goes below or meets V_{SLow}, then the comparator circuit will determine that the change in V_{Tx} meets the fall threshold and indicates a falling edge of the ASK modulation. It is to be noted that V_{SUp} and V_{SLo} may be selected to ensure a symmetrical triggering.

FIG. 5 is an exemplary timing diagram illustrating signal shape or waveform at various stages or sub-circuits of the demodulation circuit 400. The input signal to the demodulation circuit 400 is illustrated in FIG. 5 as Plot A, showing rising and falling edges from a “high” voltage (V_{High}) perturbation on the transmission antenna 121 to a “low” voltage (V_{Low}) perturbation on the transmission antenna 121. The voltage signal of Plot A may be derived from, for example, a current (I_{Tx}) sensed at the transmission antenna 121 by one or more sensors of the sensing system 300 (e.g., the current sensor 340). Such rises and falls from V_{High} to V_{Low} may be caused by load modulation, performed at the wireless receiver system(s) 130, to modulate the wireless power signals to include the wireless data signals via ASK modulation. As illustrated, the voltage of Plot A does not cleanly rise and fall when the ASK modulation is performed; rather, a slope or slopes, indicating rate(s) of change, occur during the transitions from V_{High} to V_{Low} and vice versa.

Returning to FIG. 4C, in some examples, the comparator circuit 420 may comprise a window comparator circuit. In such examples, the V_{SUp} and V_{SLo} may be set as a fraction of the power supply determined by resistor values of the comparator circuit 420. In some such examples, resistor values in the comparator circuit may be configured such that

$${V}_{Sup} = {V}_{in} [ \frac{{R}_{U 2}}{{R}_{U 1} + {R}_{U 2}} ]$$

$${V}_{SLo} = {V}_{in} [ \frac{{R}_{L 2}}{{R}_{L 1} + {R}_{L 2}} ]$$

where Vᵢₙ is a power supply determined by the comparator circuit 420. When V′_{SD} exceeds the set limits for V_{Sup} or V_{SLo}, the comparator circuit 420 triggers and pulls the output (V_{Cout}) low.

Further, while the output of the comparator circuit 420 could be output to the transmission controller 210 and utilized to decode the wireless data signals by signaling the rising and falling edges of the ASK modulation, in some examples, the SR latch 430 may be included to add noise reduction and/or a filtering mechanism for the slope detector 410. The SR latch 430 may be configured to latch the signal (Plot C) in a steady state to be read by the transmission controller 210, until a reset is performed. In some examples, the SR latch 430 may perform functions of latching the comparator signal and serve as an inverter to create an active high alert out signal.

Accordingly, the SR latch 430 may be any SR latch known in the art configured to sequentially excite when the system detects a slope or other modulation excitation. As illustrated, the SR latch 430 may include NOR gates, wherein such NOR gates may be configured to have an adequate propagation delay for the signal. For example, the SR latch 430 may include two NOR gates (NOR_{Up}, NOR_{Lo}), each NOR gate, respectively, operatively associated with the upper voltage output 422 of the comparator circuit 420 and the lower voltage output 424 of the comparator circuit 420.

In some examples, such as those illustrated in Plot C, a reset of the SR latch 430 is triggered when the comparator circuit 420 outputs detection of V_{SUp} (solid plot on Plot C) and a set of the SR latch 430 is triggered when the comparator circuit 420 outputs V_{SLo} (dashed plot on Plot C). Thus, the reset of the SR latch 430 indicates a falling edge of the ASK modulation and the set of the SR latch 430 indicates a rising edge of the ASK modulation. Accordingly, as illustrated in Plot D, the rising and falling edges, indicated by the demodulation circuit 400, are input to the transmission controller 210 as alerts, which are decoded to determine the received wireless data signal transmitted, via the ASK modulation, from the wireless receiver system(s) 130.

Returning to FIG. 5, the incoming signal V_{Tx} exemplified in the plots of FIG. 5 does not lead to excess bias or saturation, because the values of V_{BIAS} and V_{G} are configured to remain at appropriate levels, but the coupling environment may change (e.g., from strong to weak coupling), such that the existing V_{BIAS} and V_{G} are no longer appropriate and would no longer allow accurate signal detection. However, automatic gain and bias routines are applied as described herein to continually evaluate the system behavior and set V_{BIAS} and V_{G} such that accurate signal detection is provided throughout the range of allowable coupling strengths.

The demodulation circuit 400 may be particularly useful in reducing the computational burden for decoding data signals, at the transmission controller 210, when the ASK wireless data signals are encoded/decoded utilizing a pulse-width encoded ASK signals, in-band of the wireless power signals. A pulse-width encoded ASK signal is a signal wherein the data is encoded as a percentage of a period of a signal. For example, a two-bit pulse width encoded signal may encode a start bit as 20% of a period between high edges of the signal, encode “1” as 40% of a period between high edges of the signal, and encode “0” as 60% of a period between high edges of the signal, to generate a binary encoding format in the pulse width encoding scheme.

Thus, as the pulse width encoding relies solely on monitoring rising and falling edges of the ASK signal, the periods between rising times need not be constant and the data signals may be asynchronous or “unclocked.” Examples of pulse width encoding and systems and methods to perform such pulse width encoding are explained in greater detail in U.S. Pat. No. 10,892,800 titled “Systems and Methods for Wireless Power Transfer Including Pulse Width Encoded Data Communications,” to Michael Katz, which is commonly owned by the owner of the instant application and is hereby incorporated by reference in its entirety, for all that it teaches without exclusion of any part thereof.

As another example of an encoding scheme for data transmission between a wireless transmission system 120 and a wireless receiver system 150, a period-length based encoding scheme is disclosed herein. A period-length based encoding scheme may be an encoding scheme wherein messages are encoded as periods of time denoted by one or more rising edges and falling edges of a pulsed signal. Such rising and falling edges of a pulsed signal may be detected, for example, by the demodulation circuit 400 and/or the slope detector 410 thereof.

To further describe the period-length based encoding scheme, FIG. 5B is an example plot 520 of an example period-length encoded signal 525. As illustrated, each portion of the data of the signal 525 is encoded as a period of time (e.g., start bit time (T_{S}), zero bit time (T₀), one bit time (T₁), etc.). The periods of time can be defined by rising edges 530 and falling edges 532 of the signal. A rising edge 530 may be the state of the signal 525 when the signal, for the purposes of ASK communications, is in the upper or “high” state of the signal 525. Conversely, a falling edge 532 may be the state of the signal 525 when the signal, for the purposes of ASK communications, is in the lower or “low” state of the signal 525. The signal may transition from the falling edge 532 to the rising edge 530 with an upper transition 534 and the signal may transition from the rising edge 530 to the falling edge 532 with a lower transition 536. One or both of the upper transitions 534 and the lower transitions 536 may be detected by the slope detector 410 and then read, as data alerts, by the transmission controller 210 and/or any other intervening components. Of course, any of the rising edges 530, falling edges 532, upper transitions 534, and/or lower transitions 536, may be detected or decoded by other components, whether they be hardware or software components, and detection of such a signal 525 may take various other forms as well.

In the given example of FIG. 5B, a wireless receiver system 150 may be configured to encode the signal 525 by selectively damping a wireless power signal transmitted by the wireless transmission system 120, when the systems 120, 150 are coupled.

The data encoded in the signal 525 may include any number of types of messages encoded therein. For example and as illustrated, the data encoded in the signal 525 may include one or more start bits encoded as T_{S}, one or more binary zero bits encoded as T₀, and one or more binary one bits encoded as T₁. Of course, the signals encoded/decoded by the systems and methods disclosed herein are not limited to the discussed binary encoding scheme and may take various forms.

To that end and as illustrated, the wireless receiver system 150 may be configured to encode the signal 525 by beginning the transmission of a message of the signal 525 when the signal 525 is at the rising edge 530 or the “high” state of the signal 525. Then, each bit of the signal 525 is encoded as a period of time, from which the signal 525 transitions from the rising edge 530 to the falling edge 532, any number of times. For example and as illustrated, each period of the encoded signal 525 is a period of time in which the wireless receiver system 150 encodes a first lower transition 536, to a first upper transition 534, to a second lower transition 536. In other words, each period of time in the signal 525 may be encoded as a “fall-rise-fall” of the signal. Of course, each period of time for the signal 525 may be encoded with more or less transitions from the rising edge 530 to the falling edge 532 and such encoding may take various forms.

While the wireless receiver system 150 may optimally encode messages by beginning at the rising edge 530 and encoding in the aforementioned “fall-rise-fall” scheme for encoding a period of the signal 525, this may not be the optimal format for the wireless transmission system 120 and/or the demodulation circuit 400, thereof, to decode the signal 525 and/or any data thereof. Because there may be more significant perturbations in a magnetic field produced by a wide area power transfer system, it may be more difficult for the wireless transmission system 120 to detect the given periods of time in a signal based on decoding a specific “fall-rise-fall” period, of the signal.

Rather, the wireless transmission system 120 may be configured to decode the signal 525 via detecting periods of time based on “rise-fall-rise” instances of the signal 525, that correspond to the “fall-rise-fall” periods encoded by the wireless receiver system 130. To that end, each period of time may be decoded or received as a period of time in which the signal 525 is decoded as a first upper transition 534, to a first lower transition 536, to a second upper transition 534. The decoded “rise-fall-rise” bits, as periods of time (e.g., received start bit time (T′_{S}), received zero bit time (T′₀), received one bit time (T′₁), etc.) each correspond with the “fall-rise-fall” periods of time (e.g., T_{S}, T₀, T₁, etc.), such that corresponding periods of time have a substantially equal magnitude of time.

Accordingly, the timing of said periods of time may be configured such that the bits of a message are arranged in a manner where the bits are encodable and receivable by the preferred method of each system 120, 150. Further still, length of each of the periods to be encoded/decoded may be configured for each bit such that they are commonly readable as “rise-fall-rise” or “fall-rise-fall” periods of time, each correlated pair having a substantially equal magnitude of time.

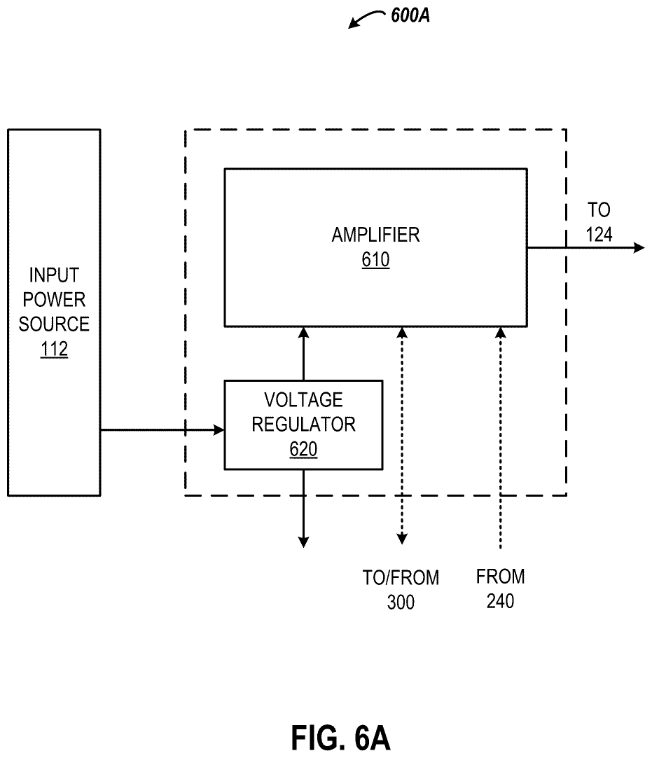

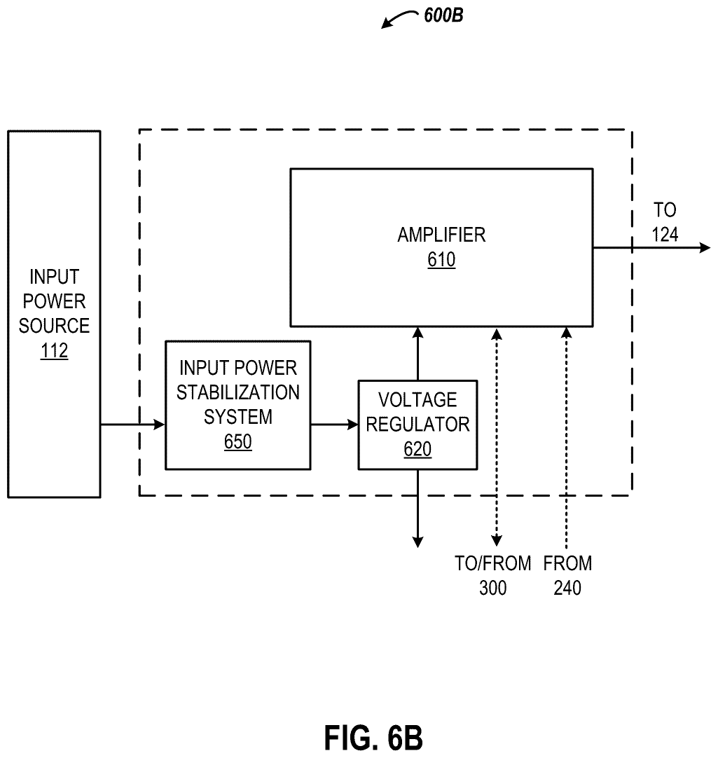

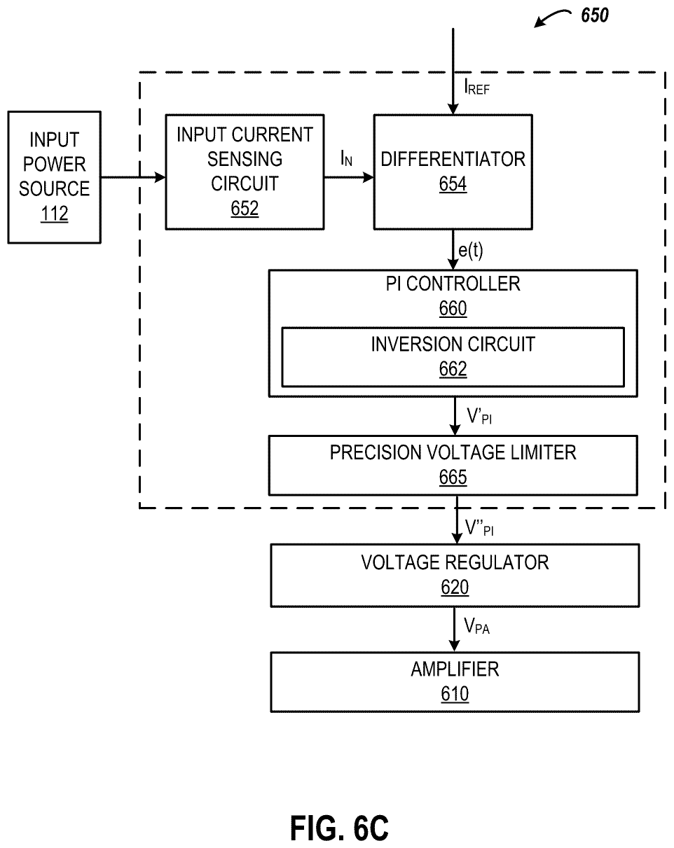

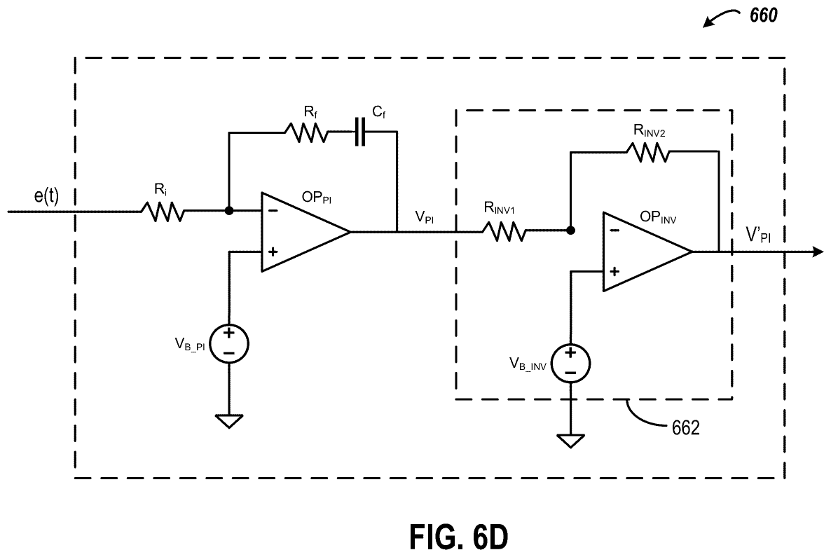

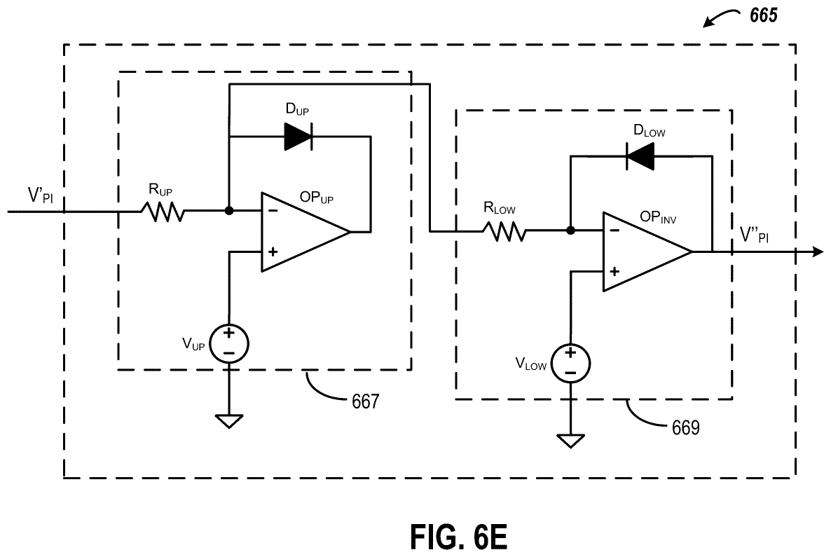

Referring now to FIG. 6A, and with continued reference to FIGS. 1-4C, a block diagram illustrating an embodiment of the power conditioning system 600A is illustrated. At the power conditioning system 600, electrical power is received, generally, as a DC power source, via the input power source 112 itself or an intervening power converter, converting an AC source to a DC source (not shown). A voltage regulator 620 receives the electrical power from the input power source 112 and is configured to provide electrical power for transmission by the transmission antenna 121 and provide electrical power for powering components of the wireless transmission system 120. Accordingly, the voltage regulator 620 is configured to convert the received electrical power into at least two electrical power signals, each at a proper voltage for operation of the respective downstream components: a first electrical power signal to electrically power any components of the wireless transmission system 120 and a second portion conditioned and modified for wireless transmission to the wireless receiver system 130. As illustrated in FIG. 2, such a first portion (e.g., “DC OUT” node in FIG. 2) is transmitted to, at least, the sensing system 300, the transmission controller 210, and the demodulation circuit 400; however, the first portion is not limited to transmission to just these components and can be transmitted to any electrical components of the wireless transmission system 120.

The second portion of the electrical power is provided to an amplifier 610 of the power conditioning system 600, which is configured to condition the electrical power for wireless transmission by the transmission antenna 121. The amplifier 610 may function as an inverter, which receives an input DC power signal from the voltage regulator 620 and/or directly from the input power source 112, then generates an AC signal as output, based, at least in part, on PWM input from the transmission control system 200. The amplifier 610 may be or include, for example, a power stage invertor, such as a dual field effect transistor power stage invertor or a quadruple field effect transistor power stage invertor. The use of the amplifier 610 for the power conditioning system 600 and, in turn, the wireless transmission system 120 enables wireless transmission of electrical signals having much greater amplitudes than if transmitted without an amplifier. For example, the addition of the amplifier 610 may enable the wireless transmission system 120 to transmit electrical energy as an electrical power signal having electrical power from about 10 mW to about 500 W.

In some examples, the amplifier 610 may be or may include one or more class-E power amplifiers. Class-E power amplifiers are efficiently tuned switching power amplifiers designed for use at high frequencies (e.g., frequencies from about 1 MHz to about 1 GHz). Generally, a class-E amplifier employs a single-pole switching element and a tuned reactive network between the switch and an output load (e.g., the transmission antenna 121). Class E amplifiers may achieve high efficiency at high frequencies by only operating the switching element at points of zero current (e.g., on-to-off switching) or zero voltage (off to on switching). Such switching characteristics may minimize power lost in the switch, even when the switching time of the device is long compared to the frequency of operation.

However, the amplifier 610 is certainly not limited to being a class-E power amplifier and may be or may include one or more of a class D amplifier, a class EF amplifier, an H invertor amplifier, and/or a push-pull invertor, among other amplifiers that could be included as part of the amplifier 610.

Turning now to FIG. 6B, another example power conditioning system 600B is illustrated. The power conditioning system 600B may include various common components to those of the power conditioning system 600A and, accordingly, said components are similarly labelled (e.g., the amplifier 610, the voltage regulator 620, etc.). Further, the power conditioning system 600B includes an input power stabilization system 650.

The input power stabilization system 650 may be configured to receive input power from the input power source 112 and generate a stabilized DC power, for use by downstream components of the wireless transmission system 120 (e.g., the voltage regulator 620, the amplifier 610, etc.). Because power input requested by the wireless transmission system 120 from the input power source 112 may be affected due to changes in system transfer impedance due to coupling variances between the wireless transmission system 120 and a wireless receiver system 150, the input power stabilization system 650 may be utilized to ensure an input current to the wireless transmission system 120 does not exceed a maximum input current that the input power source 112 is capable of providing, regardless of the current draw requested by the wireless transmission system 120.

The input power stabilization system 650 is illustrated in greater detail in the block diagram of FIG. 6C. At a high level, the input power stabilization system is configured to receive an input power at an input current (I_{IN}), compare I_{IN} with a reference current (I_{REF}) that is indicative of a desired input current, and alter the input power to produce an output power having a voltage (V_{PA}) for input to the amplifier, wherein V_{PA} is configured based on the desired input current.

The input power source 112 may be an input from a power source external to the power conditioning system 600B, such as, but not limited to, an input received from an outside source and connected to the wireless transmission system 120 via an electrical connection (e.g., a cable, a metal contact, etc.), an input power received from a power storage associated with the wireless transmission system 120, among other known input power sources. In some examples, the input power source 112 may be provided to the power conditioning system 600B and/or the wireless transmission system 120, via a USB interface, such as, but not limited to, a USB-A and/or a USB-micro interface.

As illustrated, the input power stabilization system may include an input current sensing circuit 652, which determines the raw input current (I_{IN}) received from (or requested from) the input power source 112. At a high level, the input current sensing circuit 652 may be configured to continuously determine an input current of the input power over time. To that end, the input current sensing circuit 652 is configured to continuously monitor the power input from the input power source 112 and determine a value for I_{IN}, over time. In some examples the input current sensing circuit 652 may include one or more filters configured for removing some aspect of a signal (e.g., harmonic ripples in voltage in the current sensed).

Based on the sensed electrical information, the input current sensing circuit 652 determines I_{IN}, over time. The input current sensing circuit 652 disclosed herein is for the purpose of example and I_{IN} may be determined by various other forms of circuits and/or functionalities.

I_{IN} is, then, utilized as input by a differentiator circuit 654. At a high level, the differentiator circuit may be configured to (i) receive the input current of the input power over time, (ii) define a reference value for a stabilized input current, (iii) compare the input current of the input power over time with the reference value for the stabilized input current, and (iv) determine and output an error value based on comparison of the input current of the input power over time with the reference value for the stabilized input current. To that end, the differentiator circuit 654 may be any circuit, either comprised of discrete components or included as an integrated circuit (IC) or a component of an IC, that functions to receive I_{IN}, compare I_{IN} with I_{REF}, and output an error value, over time, (e(t)) based on the comparison between I_{IN} and I_{REF}.

I_{REF} may be set via, for example, one or more operational amplifiers (OpAmps) of or associated with the differentiator circuit 654. To that end, I_{REF} may be configured via one or more resistors connected to such an OpAmp that sets the voltage, to achieve I_{REF}, based on an input bias voltage. I_{REF} may be any voltage that is selected for optimal or desired operation of the wireless power transmitter. In some examples, I_{REF} may be in a range of about 450 mA to about 550 mA. Further still, in such examples, V_{REF} may be set in a range of about 490-500 mA. However, I_{REF} may take any other voltage value or range and setting of I_{REF} may take various forms as well.

The output of the differentiator circuit 654, e(t), represents the error or difference between the sensed I_{IN} and the desired I_{REF}. The time series e(t) variable is utilized as feedback for control of the input power stabilization system 650.

To that end, e(t) may be input, as a current, to a proportional integration (PI) controller 660. A PI controller, generally, refers to a control loop mechanism that utilizes a time series error value (e.g., e(t),) and applies a correction based on a setpoint value (e.g. I_{REF}). When utilized within the wireless transmission system 120, the PI controller 660 functions to receive I_{IN} from an external power source and generate a stabilized DC power, the stabilized DC power based on I_{REF}.

Thus, the PI controller 660 receives e(t) and outputs V′PI, which is a corrected input voltage output of the PI controller 660, to the voltage regulator 620. In some examples, a precision voltage limiter 665 limits V′PI further to generate V″PI, which will be discussed in more detail below.

FIG. 6D is a schematic illustrating a non-limiting example of a circuit implementation of the PI controller 660; however, the PI controller 660 may take various other forms, either in discrete or integrated circuitry.

In the example of FIG. 6D the PI controller 660 is configured based on a proportional gain factor (K_{P}) and an integral gain factor (Kᵢ), which may be configured based on values selected for resistors Rᵢ and R_{f} and capacitor C_{f}. These values are utilized as input or configuration parameters for the PI OpAmp (OP_{PI}) that carries out some functionality of the PI controller. In some examples, K_{P} may be defined as:

$${K}_{P} = \frac{{R}_{f}}{Ri} .$$

In some examples, Kᵢ may be defined as:

$${K}_{i} = \frac{1}{RiCf} .$$

When implementing the PI controller 660, if the PI controller 660 is desired to operate in a more responsive manner, then K_{P} should be increased (e.g., choose resistors Rᵢ and R_{f} to make K_{P} greater than a prior design). Conversely, if the PI controller 660 is desired to operate in a less responsive manner, then K_{P} should be decreased (e.g., choose resistors Rᵢ and R_{f} to make K_{P} less than a prior design).

Further still, in some examples, operations of the PI controller 660 may be constrained by a crossover frequency (f_{c}) for the PI controller 660, which may be defined as:

$${f}_{c} = \frac{1}{2 π {R}_{f} {C}_{f}} .$$

The PI controller 660 further may receive input bias voltage V_{B_PI}, which may be necessary to operate. In some examples, V_{B_PI} may be about 0.5 V. However, V_{B_PI} may be any value for operating the PI controller 660.

The output of the PI controller 660 (V_{PI}) may then be, optionally, processed by an inversion circuit 662, which may invert V_{PI} to an inverted PI output V′_{PI}. The inversion circuit 662 may be included in examples wherein another downstream component of the wireless transmission system 120 (e.g., the voltage regulator 620) also inverts a downstream input voltage (e.g., V_{PI} or a derivative thereof). In some examples, the inversion circuit 662 includes two resistors (R_{INV1}, R_{INV2}), an inverting OpAmp (OP_{INV}), and receives input from an inverting bias voltage V_{B_INV}. In some examples, R_{INV1} and R_{INV2} may be substantially similar in resistance value.

The inversion circuit 662 may be configured to invert the output of the PI controller 660 to match a voltage reference behavior of a downstream component of the wireless transmission system 120. However, the inversion circuit 662 is not limited to the disclosed implementation and may take various forms known to those of skill in the art.

Returning now to FIG. 6C, after V′_{PI} is output by the PI controller 660, optionally, V_{PI} may be further processed by a precision voltage limiter 665, which may provide further stability to the resultant output of the input voltage stabilization system 650. The precision voltage limiter 665 may be included to prevent providing excess power to downstream components of the wireless transmission system 120, when such power is not necessary. The precision voltage limiter may function as a saturation block that limits the voltage range by introducing both a lower and upper limit for VPI, which then may be used to bias input of the voltage regulator 620. The output voltage of the voltage regulator 620 is then output to the amplifier 610.

An example of the precision voltage limiter 665 is illustrated in FIG. 6E, which includes an upper limit saturation circuit 667 and a lower limit saturation circuit 669. The upper limit saturation circuit 667 utilizes input components (upper resistor (R_{UP}), upper bias voltage (V_{UP}), and V′_{PI}) to an upper OpAmp (OP_{UP}) to determine if V′_{PI} is below the upper limit for saturation of the voltage regulator 620. If V′_{PI} is too high, an upper diode (D_{UP}) prevents V′_{PI} proceeding in the current flow of the circuit and OP_{UP} corrects V′_{PI} based on the upper limit for saturation. The lower limit saturation circuit 669 utilizes input components (lower resistor (R_{LOW}), lower bias voltage (V_{LOW}), and V′_{PI}) to a lower OpAmp (OP_{LOW}) to determine if V′_{PI} is below the upper limit for saturation of the voltage regulator 620. If V′_{PI} is too low, a lower diode (D_{UP}) prevents V′_{PI} proceeding in the current flow of the circuit and OP_{LOW} corrects V′_{PI} based on the upper limit for saturation. The resultant output of the precision voltage limiter 665, thus, is V″_{PI}.

Returning now to FIG. 6C, the resultant output of the input voltage stabilization circuit is then provided to bias the voltage regulator 620, such that a proper, stabilized input (V_{PA}) can be provided the amplifier 610. Thus, by controlling the input power and limiting the input current and/or voltage to the power amplifier, efficient and stable operations of the wireless transmission system 120, that are associated with the input power, are maintained.

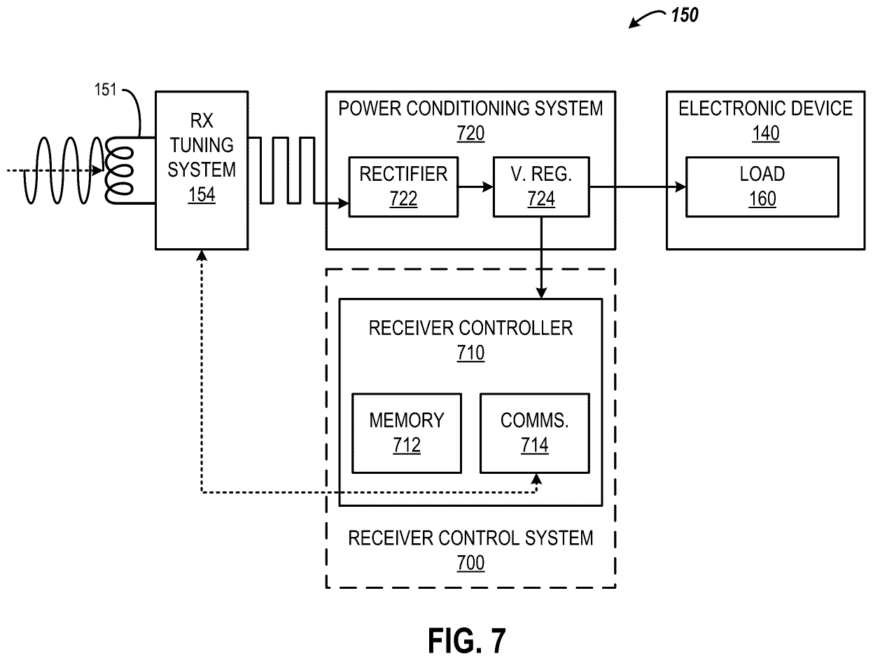

Turning now to FIG. 7 and with continued reference to, at least, FIGS. 1-2, the wireless receiver system 150 is illustrated in further detail. The wireless receiver system 150 is configured to receive, at least, electrical energy, electrical power, electromagnetic energy, and/or electrically transmittable data, via near field magnetic coupling from the wireless transmission system 120, via the transmission antenna 121. As illustrated in FIG. 7, the wireless receiver system 150 includes, at least, the receiver antenna 151, a receiver tuning system 154, a power conditioning system 720, and a receiver control system 700. The receiver tuning system 154 may be configured to substantially match the electrical impedance of the wireless transmission system 120. In some examples, the receiver tuning system 154 may be configured to dynamically adjust and substantially match the electrical impedance of the receiver antenna 151 to a characteristic impedance of the power generator or the load at a driving frequency of the transmission antenna 121.

As illustrated, the power conditioning system 720 includes a rectifier 722 and a voltage regulator 724. In some examples, the rectifier 722 is in electrical connection with the receiver tuning system 154. The rectifier 722 is configured to convert the received electrical energy from an alternating current electrical energy signal to a direct current electrical energy signal. In some examples, the rectifier 722 is comprised of at least one diode. Some non-limiting example configurations for the rectifier 722 include, but are not limited to including, a full wave rectifier, a center tapped full wave rectifier, a full wave rectifier with filter, a half wave rectifier, a half wave rectifier with filter, a bridge rectifier, a bridge rectifier with filter, a split supply rectifier, a single phase rectifier, a three phase rectifier, a voltage doubler, a synchronous voltage rectifier, a controlled rectifier, an uncontrolled rectifier, a half controlled rectifier, and the like. As electronic devices may be sensitive to voltage, additional protection of the electronic device may be provided by clipper circuits or devices. In this respect, the rectifier 722 may further include a clipper circuit or a clipper device, which is a circuit or device that removes either the positive half (top half), the negative half (bottom half), or both the positive and the negative halves of an input AC signal. In other words, a clipper is a circuit or device that limits the positive amplitude, the negative amplitude, or both the positive and the negative amplitudes of the input AC signal.

Of course, other example implementations, including additional or alternative components for the rectifier 722, are contemplated, as well.

Some non-limiting examples of a voltage regulator 724 include, but are not limited to, including a series linear voltage regulator, a buck convertor, a low dropout (LDO) regulator, a shunt linear voltage regulator, a step up switching voltage regulator, a step down switching voltage regulator, an invertor voltage regulator, a Zener controlled transistor series voltage regulator, a charge pump regulator, and an emitter follower voltage regulator. The voltage regulator 724 may further include a voltage multiplier, which is as an electronic circuit or device that delivers an output voltage having an amplitude (peak value) that is, for example, two, three, or more times greater than the amplitude (peak value) of the input voltage. The voltage regulator 724 is in electrical connection with the rectifier 722 and configured to adjust the amplitude of the electrical voltage of the wirelessly received electrical energy signal, after conversion to AC by the rectifier 722. In some examples, the voltage regulator 724 may include a LDO linear voltage regulator; however, other voltage regulation circuits and/or systems are contemplated. As illustrated, the direct current electrical energy signal output by the voltage regulator 724 is received at the load 160 of the electronic device 140. In some examples, a portion of the direct current electrical power signal may be utilized to power the receiver control system 700 and any components thereof; however, it is certainly possible that the receiver control system 700, and any components thereof, may be powered and/or receive signals from the load 160 (e.g., when the load 160 is a battery and/or other power source) and/or other components of the electronic device 140.

The receiver control system 700 may include, but is not limited to including, a receiver controller 710, a communications system 714, and a memory 712.

The receiver controller 710 may be any electronic controller or computing system that includes, at least, a processor which performs operations, executes control algorithms, stores data, retrieves data, gathers data, controls and/or provides communication with other components and/or subsystems associated with the wireless receiver system 150. The transmission controller 210 includes at least one processor, at least one machine-readable medium, and program instructions stored on the at least one machine-readable medium which, when executed by the at least one processor, cause the transmission controller 210 to perform any of the functions disclosed herein. The receiver controller 710 may be a single controller or may include more than one controller disposed to control various functions and/or features of the wireless receiver system 150.

Functionality of the receiver controller 710 may be implemented in hardware and/or software and may rely on one or more data maps relating to the operation of the wireless receiver system 150. To that end, the receiver controller 710 may be operatively associated with the memory 712. The memory 712 may include one or both of internal memory, external memory, and/or remote memory (e.g., a database and/or server operatively connected to the receiver controller 710 via a network, such as, but not limited to, the Internet). The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), and graphics double data rate synchronous dynamic RAM (GDDR SDRAM, GDDR2, GDDR3, GDDR4, GDDR5, a flash memory, a portable memory, and the like. Such memory media are examples of non-transitory computer and/or machine readable memory media.

Further, while particular elements of the receiver control system 700 are illustrated as subcomponents and/or circuits (e.g., the memory 712, the communications system 714, among other contemplated elements) of the receiver control system 700, such components may be external of the receiver controller 710. In some examples, the receiver controller 710 may be and/or include one or more integrated circuits configured to include functional elements of one or both of the receiver controller 710 and the wireless receiver system 150, generally. As used herein, the term “integrated circuits” generally refers to a circuit in which all or some of the circuit elements are inseparably associated and electrically interconnected so that it is considered to be indivisible for the purposes of construction and commerce. Such integrated circuits may include, but are not limited to including, thin-film transistors, thick-film technologies, and/or hybrid integrated circuits.

In some examples, the receiver controller 710 may be a dedicated circuit configured to send and receive data at a given operating frequency. For example, the receiver controller 710 may be a tagging or identifier integrated circuit, such as, but not limited to, a tag and/or labelling integrated circuit.

The communications system 714 may be any circuit, instructions, and/or functionality that can be utilized in conjunction with the receiver controller 710 to modulate and/or demodulate data signals that are encoded in the wireless power transfer, with the wireless power transfer acting as a carrier signal for the modulated/demodulated signals. For example, the communications system 714 may be configured to modulate the power signal between antennas 121, 151 to encode data signals in-band of the power signals in accordance with the aforementioned pulse width encoding schemes discussed above. Additionally or alternatively, the communications system 714 may include circuits, systems, and/or functionality for demodulating data signals in band of the power signals between the antennas 121, 151. For example, the communications system 714 may include demodulation circuits similar to and/or having like or same elements to those of the demodulation circuit 400 discussed above with respect to FIGS. 2-5. Of course, the communications system 714 may take other forms, for demodulating and/or modulating a power signal in accordance with encoded/decoded signals, as well.

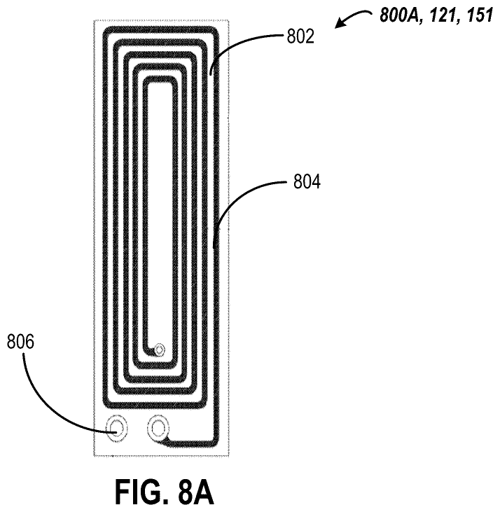

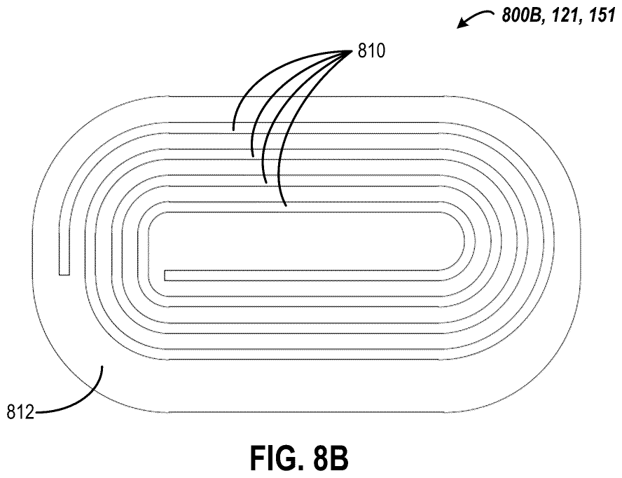

FIG. 8A illustrates an example, non-limiting embodiment of one or more of a first antenna 800A, which may be utilized as the transmitter antenna 121, the receiver antenna 151, or any other antennas or coils discussed herein. The antenna 800A may be used with any of the systems, methods, and/or apparatus disclosed herein. In the illustrated embodiment, the antenna 800A is a flat spiral coil configuration.

The antenna 800A may be a printed circuit board (PCB) or flexible printed circuit board (FPC) antenna, having a plurality of turns 804 of a conductor and one or more connectors 806, all disposed on a substrate 802 of the antenna 800A. While the antenna 800A is illustrated, in FIG. 8A, having a certain number of turns and/or layers, the PCB or FPC antenna may include any number of turns or layers. The PCB or FPC antenna 800A of FIG. 8A may be produced via any known method of manufacturing PCB or FPCs known to those skilled in the art.

In another embodiment of an antenna 800B, illustrated in FIG. 8B, which may be utilized as the antenna 121, the antenna 151, or any other antenna disclosed herein, may be a wire wound antenna, wherein the antenna is a conductive wire wound in a particular pattern and having any number of turns 810. The wire wound antenna 800B may be free standing within an associated structure or, in some examples, the wire wound antenna 800B may be either held in place or positioned using a wire holder 812.

Of course, other examples for implementation of the transmission antenna 121 and/or the receiver antenna 151 are contemplated, as well.

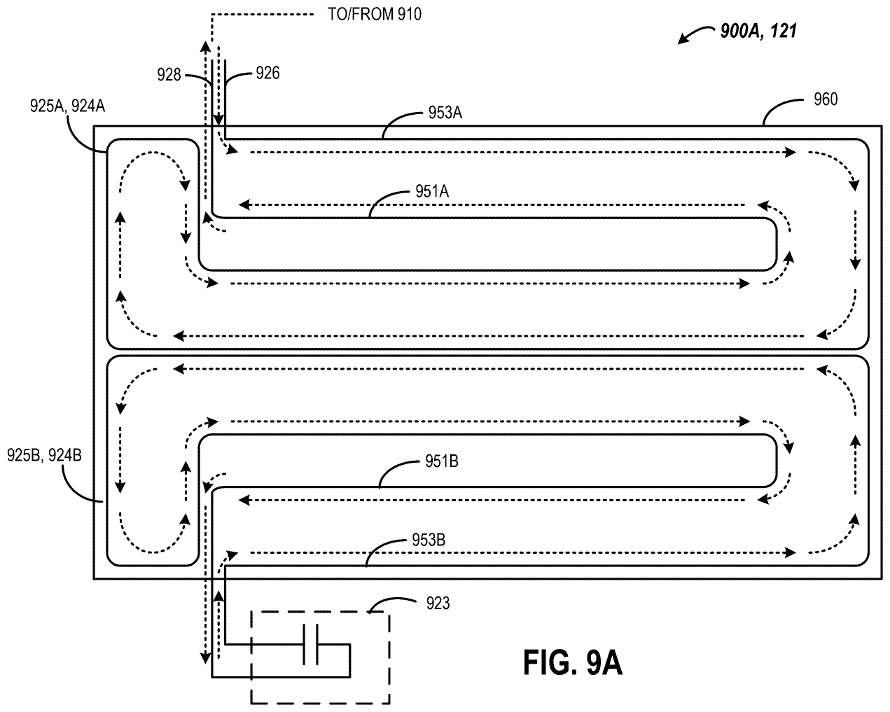

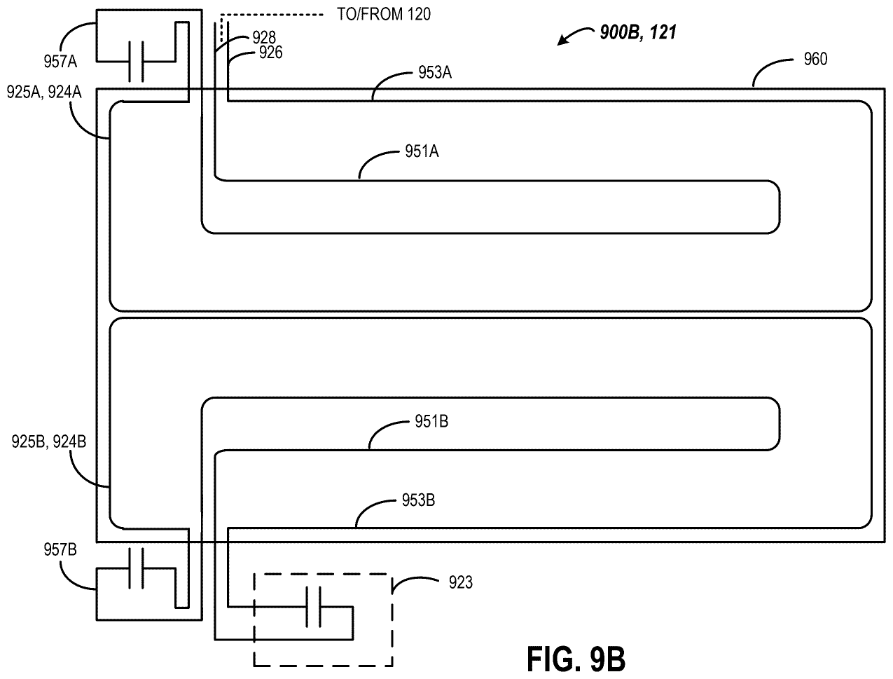

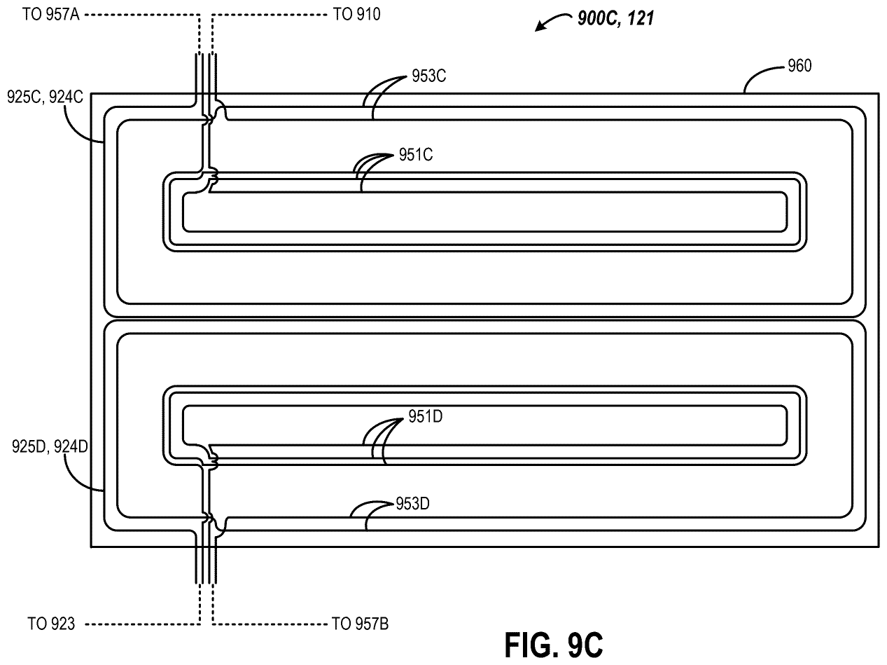

Turning now to FIG. 9A, an example of a wireless power transmission antenna 921A is illustrated, which may be is configured for transmitting wireless power to a receiver system 150 over a large charge area. The antenna 921A may be utilized as the transmission antenna 21 in any of the aforementioned wireless transmission systems 20. The transmission antenna(s) 921 include multiple transmission coils 925, wherein at least one transmission coil is a source coil 925A and at least one transmission coil 925 is an internal repeater coil 925B. The source coil 925A is comprised of a first continuous conductive wire 924A and includes a first outer turn 953A and a first inner turn 951A. While illustrated with only one first outer turn 953A and one first inner turn 951A, it is certainly contemplated that the antenna 921A may include multiple outer turns 953A and inner turns 951A. The first conductive wire begins at a first source terminal 926, which leads to or is part of the beginning of the first outer turn 953A, and ends at a second source terminal, which is associated or is part of the ending 928 of the first inner turn 951A.

The source coil 925A is configured to connect to one or more electronic components 910 of the wireless transmission system 120. The electronic components 910 may include, but are not limited to including, the transmission control system 200 and/or one or more components thereof, the sensing system 300 and/or one or more components thereof, the demodulation circuit 400 and/or one or more components thereof, the power conditioning system 600 and/or one or more components thereof, among other components of the wireless transmission system 120. Of course, the electronic components 910 may include one or more additional components of or associated with the wireless transmission system 120 and/or the associated host device 110.

The internal repeater coil 925B may take a similar shape to that of the source coil 925A, but is not directly, electrically connected to the one or more electrical components 910 of the wireless transmission system '20. Rather, the internal repeater coil 925B is a repeater configured to have a repeater current induced in it by the source coil 925A.

Configuration of the inner turns 951 and outer turns 953, with respect to one another, of the coils 925 is designed for controlling a direction of current flow through each of the coils 925. Current flow direction is illustrated by the dotted lines in FIG. 22A. As illustrated, the current may enter the source coil 925A, from the one or more electrical components 910, at the first source terminal at the beginning of the first outer turn 953A and then flow through the first outer turn in a first source coil direction. Said source coil direction may be, for example, a clockwise direction, as illustrated. Then, at the end of the first outer turn 953A, where the first outer turn 953A turns into the first inner turn 951A, the current will change directions to a second source direction, which is substantially opposite of the first source direction. In some examples and as illustrated, the second source direction may be a counter-clockwise direction, which is substantially opposite of the clockwise direction of the current flow through the first outer turn 953A.

The internal repeater coil 925B is configured such that a current is induced in it by the source coil 925A and direction(s) of the current induced in the internal repeater coil 925B is/are illustrated by the dotted lines in FIG. 22A. The induced current of the internal repeater coil 925B may have a first repeater direction, flowing through the second outer turn 953B of the internal repeater coil 925B. The first repeater direction may be, for example and as illustrated, a counter-clockwise direction. Then, at the end of the second outer turn 953B, where the second outer turn 953B turns into the second inner turn 951B, the current will change directions to a second repeater direction, which is substantially opposite of the first repeater direction, In some examples and as illustrated, the second source direction may be a clockwise direction, which is substantially opposite of the counter-clockwise direction of the current flow through the second outer turn 953B.

As illustrated and described, the first repeater direction (counter-clockwise) may be substantially opposite of the first source direction (clockwise). Thus, as one views the antenna 921 both from left-to-right and from top-to-bottom, the current direction reverses from turn to turn. By reversing current directions from turn-to-turn both laterally (side to side) and from top-to-bottom, optimal field uniformity may be maintained. By reversing current directions amongst inner and outer turns 951, 953, both laterally and top-to-bottom, a receiver antenna 151 travelling across the charge area of the antenna 921 will more often be positioned more closer-to-perpendicular with the magnetic field emanating from the antenna 921. Thus, as a receiver antenna 151 will best couple with the transmission antenna 921 at points of perpendicularity with the magnetic field, the charge area generated by the antenna 921 will have greater uniformity than if all of the turns 951, 953 carried the current in a common direction.

As illustrated, the source coil 925A and the internal repeater coil 925B may be configured to be housed in a common, unitary housing 960. By utilizing the internal repeater coil 925B, rather than one larger source coil, EMI benefits may be seen, as a shorter wire connected to the source may reduce EMI issues. Additionally, by utilizing the internal repeater coil 925B, the aforementioned reversals of current direction may be better achieved, which enhances uniformity and metal resilience in the transmission antenna 921.

In some examples, while the internal repeater coil 925B may be a “passive” inductor (e.g., not connected directly, by wired means, to a power source), it still may be connected to one or more components of a repeater tuning system 923A. The repeater tuning system 923A may include one or more components, such as a tuning capacitor, configured to tune the internal repeater coil 925B to operate at an operating frequency similar to that of the source coil 925A and/or any receiver antenna(s) 31, to which the repeater coil 925B intends to transfer wireless power. The repeater tuning system 923A may be positioned, in a signal path of the internal repeater coil 925B, connecting the beginning of the second outer turn 953B and the ending of the second inner turn 951B, as illustrated.

One or more of the source coil 925A, the internal repeater coil 925B, and combinations thereof may form or combine to form a substantially rectangular shape, as illustrated. In some examples, such substantially rectangular shape(s) of one or more of the source coil 925A, the internal repeater coil 925B, and combinations thereof may additionally have rounded edges, as illustrated in FIG. 22A. In some such examples, shape of the coils 925A, 925B may both be oriented in a “column” type rectangular formation, wherein, when viewed in a top view perspective, the coils 925 are arranged from top to bottom in a singular row. Alternatively, the coils 925 may be arranged in a “row” type formation, where the coils 925 are arranged next to one another in a “side-to-side” lateral fashion. Any of the subsequently discussed antennas 900, having a source-internal repeater configuration, may have either a row formation or a column formation.

In some examples, the repeater tuning system 923A may be disposed on a substrate that is independent of the one or more electrical components 910 of the wireless transmission system 20. In such examples, the substrate and/or the tuning system 923 absent a substrate may be positioned radially inward of the second outer turn 953. Alternatively, the tuning system 923 may be similarly connected to the outer and inner turns 953B, 951B, but the tuning system 923 and/or the associated substrate may be positioned radially inward of the second inner turn 951B.

Further still, in some examples wherein the repeater tuning system 923B is disposed radially inward of the second outer turn 953B, one or more capacitors of the repeater tuning system 923 may be interdigitated capacitors. An interdigitated capacitor is an element for producing capacitor-like characteristics by using microstrip lines, which can be disposed as conductive materials on a substrate or other surface. To that end, capacitors of the repeater tuning system 923 may be interdigitated capacitors disposed on the substrate 962. Additionally or alternatively, interdigitated capacitors of the repeater tuning system 923 may be disposed on another surface, such as a dielectric surface of the housing 960.

Turning now to FIG. 9B, another example of an antenna 900B is illustrated, the antenna 921E having a source-internal repeater configuration, similar to those of FIG. 9A and, thus, including like or similar elements to those of FIG. 9A, which share common reference numbers and descriptions herein. In contrast to the antennas 900 of FIG. 9A, the source coil 925A and the internal repeater coil 925B of include, respectively, inter-turn capacitors 957A, 957B. An inter-turn capacitor may be any capacitor that is disposed in between the inner and outer turns 951, 953 of either a source coil 925A or an internal repeater coil 925B. The inter-turn capacitors 957 may be configured to mitigate electronic field (or E-Field) emissions generated by one or both of the antenna(s) 921 and the one or more electrical components 910.

The use of inter-turn capacitors 957 in the antenna 900B may decrease sensitivity of the antenna 900B, with respect to parasitic capacitances or capacitances outside of the scope of wireless power transfer (e.g., a natural capacitance of a human limb or body). Thus, the antenna 900B may be less affected by such parasitic capacitances, when introduced to the field generated by the antenna 900B, when compared to antennas 121, 900 not including inner turn capacitors 957.

The inner turn capacitor 957, further, may be tuned to maintain phase of the AC signals throughout the respective coils 925 and, thus, values of the inter-turn capacitors 957 may be based on one or more of an operating frequency for the system(s) 100, 120, 150, inductance of each turn of the coils 925, and/or length of the continuous conductive wire 924 of a respective coil 925. By maintaining phase through a coil 925 with the inter-turn capacitors 957, excess or unwanted E-field emissions may be mitigated, as there is less variance in voltages across a coil 925.

The inter-turn capacitors 957 may be tuned to prevent E-Field emissions, such that the wireless transmission system 120 can properly operate within statutory or standards-body based guidelines. For example, the inter-turn capacitors may be tuned to reduce E-field emissions such that the wireless transmission system 20 is capable of proper operations within radiation limits defined by the International Commission on Non-Ionizing Radiation Protection (ICNIRP).

In some examples, the inter-turn capacitors 957 may be positioned within bounds of the outer turns 953 of the coils 925. Accordingly, in some such examples, the inter-turn capacitors 957 may be disposed on a substrate that is positioned radially inward of an outer turn 953. In some such examples, the inter-turn capacitors 957 may be interdigitated capacitors. Further still, in some such examples, interdigitated inter-turn capacitors 957 may be disposed on a dielectric surface of the housing 960.

Turning now to FIG. 9C, another antenna 900C is illustrated, having a source coil 925C and repeater coil 925F configuration and, thus, including like or similar elements to those of FIGS. 9A and 9B, which share common reference numbers and descriptions herein. The antenna 900C includes a first plurality of outer turns 953C, a first plurality of inner turns 951C, a second plurality of outer turns 953D, and a second plurality of inner turns 951D. The source coil 925C is connected to the one or more electrical components 910 via a first source terminal proximate to a beginning of the first plurality of outer turns 953C and a second source terminal proximate to an ending of the first plurality of inner turns 951C. The internal repeater coil 925D may be connected to a repeater tuning system 923 via a first repeater terminal proximate to a beginning of the second plurality of outer turns 953D and a second repeater terminal proximate to an ending of the second plurality of inner turns 951D. Inter-turn capacitors may 957 be connected in between the first plurality of outer turns 953C and the first plurality of inner turns 951C and in between the second plurality of outer turns 953D and the second plurality of inner turns 951D. In some examples, the first and second plurality of outer turns 953C, 953C may include about 2 turns and the first and second plurality of inner turns 951D, 951D may include about 3 turns.

While illustrated as individual blocks and/or components of the wireless transmission system 120, one or more of the components of the wireless transmission system 120 may combined and/or integrated with one another as an integrated circuit (IC), a system-on-a-chip (SoC), among other contemplated integrated components. To that end, one or more of the transmission control system 200, the power conditioning system 600, the sensing system 300, the transmission antenna 121, and/or any combinations thereof may be combined as integrated components for one or more of the wireless transmission system 120, the wireless power transfer system 100, and components thereof. Further, any operations, components, and/or functions discussed with respect to the wireless transmission system 120 and/or components thereof may be functionally embodied by hardware, software, and/or firmware of the wireless transmission system 20.

Similarly, while illustrated as individual blocks and/or components of the wireless receiver system 150, one or more of the components of the wireless receiver system 150 may combined and/or integrated with one another as an IC, a SoC, among other contemplated integrated components. To that end, one or more of the components of the wireless receiver system 150 and/or any combinations thereof may be combined as integrated components for one or more of the wireless receiver system 150, the wireless power transfer system 100, and components thereof. Further, any operations, components, and/or functions discussed with respect to the wireless receiver system 150 and/or components thereof may be functionally embodied by hardware, software, and/or firmware of the wireless receiver system 130.

Further still, functionality disclosed herein for carrying out any of the systems and methods disclosed herein may be executed as software. For example, one or more controllers (e.g., the transmission controller 210, the receiver controller 710, etc.) may carry out said functionality of the systems and methods disclosed herein. To that end, any controller disclosed herein includes at least one processor and any controller disclosed herein includes or is otherwise associated with at least one machine-readable medium (e.g., the memory 212, the memory 712, etc.). Said machine-readable medium may comprise program instructions which, when executed by the at least one process of said controller, cause the controller to carry out some functionality disclosed that is associated with the disclosed systems and methods.

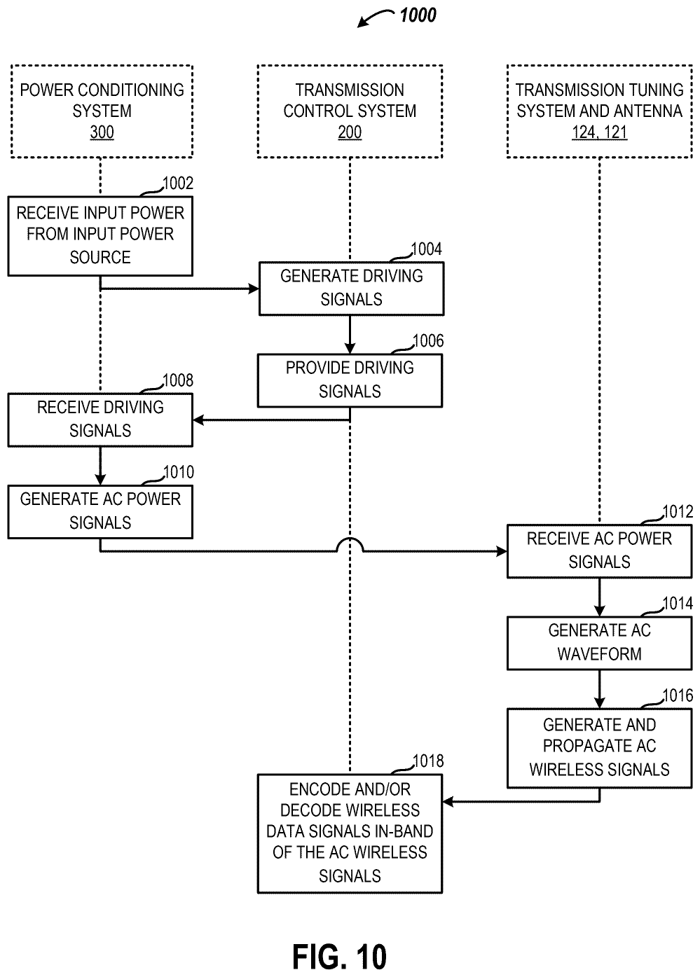

Turning now to FIG. 10, an example method 1000 of operating a wireless transmission system (e.g., the wireless transmission system 120) is illustrated. As illustrated, certain functions of the method 1000 are indicated as being performed by one of the power conditioning system 600, the transmission control system 200, or the transmission tuning system 124 and antenna 121, as indicated by the dotted lines connecting blocks to said components; however, the method 1000 is not limited to having the indicated steps specifically performed by only the indicated connected component. One or more functions of the method 1000 may be carried out by additional or alternative components, as known by those having skill in the art. The functionality discussed below may be carried out using any of the disclosed technology discussed above.

The method 1002 beings with the wireless transmission system 120 receiving input power from an input power source. Then, as indicated by block 1004, the input power may be utilized in generating driving signals for the wireless transmission system 120. In some examples, as indicated in block 1006, the driving signals may be provided to the power conditioning system 600, by the transmission control system 200.

The driving signals may be received by the power conditioning system 600 and utilized to generate AC power signals (block 1010), which, in some examples, are received by the transmission tuning system 124 and antenna 121 (block 1012). Then, based on the driving signals, the wireless transmission system 120 generates an AC waveform based on the driving signals (block 1014) to then generate and propagate AC wireless signals based on said waveform (block 1016). In some examples, the wireless transmission system 120 may optionally encode and/or decode data signals in-band of the propagated AC wireless signals, in accordance with the technology disclosed above.

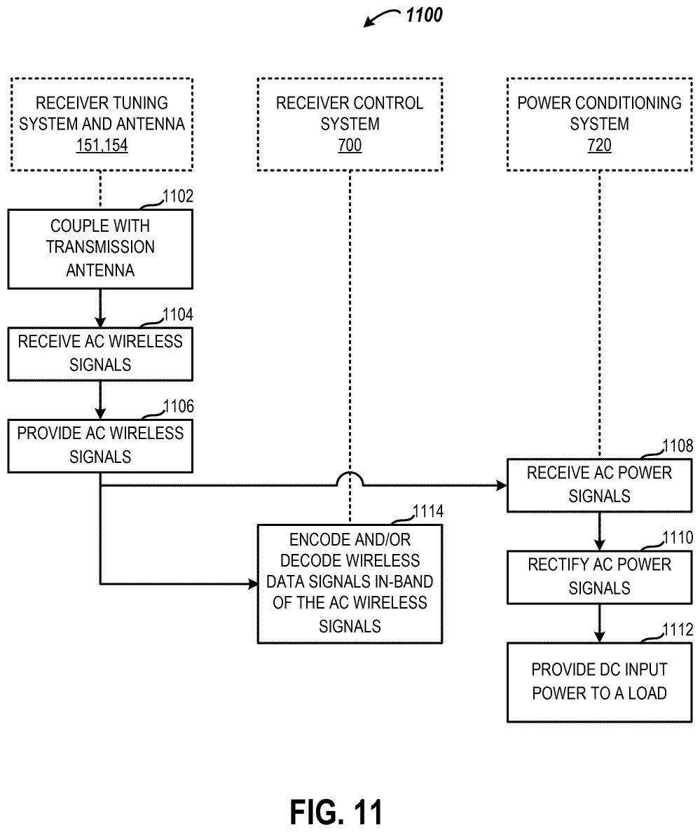

Turning now to FIG. 11, an example method 1100 of operating a wireless receiver system (e.g., the wireless transmission system 120) is illustrated. As illustrated, certain functions of the method 1100 are indicated as being performed by one of the power conditioning system 720, the receiver control system 700, or the receiver tuning system 154 and antenna 151, as indicated by the dotted lines connecting blocks to said components; however, the method 1100 is not limited to having the indicated steps specifically performed by only the indicated connected component. One or more functions of the method 1100 may be carried out by additional or alternative components, as known by those having skill in the art. The functionality discussed below may be carried out using any of the disclosed technology discussed above.

The method 1100 begins when the wireless receiver system 150 couples with a wireless transmission system (e.g., the wireless transmission system 120), via NFMI, as illustrated in block 1102. Then, the wireless receiver system 150 may receive AC wireless signals, such as wireless power signals, as illustrated in block 1104.

The antenna 151 and/or the receiver tuning system 154 may provide the AC wireless signals (block 1106) to the power conditioning system, which receives that AC wireless signals (block 1108). The wireless receiver system 150 may then rectify the AC wireless signals to generate DC output power (block 1110) to then, for example, provide meaningful electrical power to a load associated with the wireless receiver system 150 (block 1112). In some examples, the wireless receiver system 150 may optionally encode and/or decode data signals in-band of the received AC wireless signals, in accordance with the technology disclosed above.

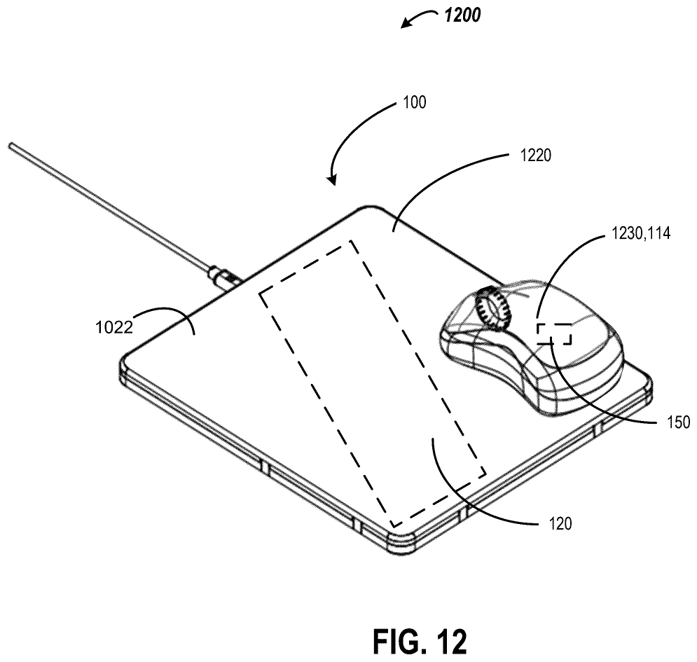

Turning now to FIG. 12, example computer peripherals are illustrated, such as a mouse 1230 and a mouse pad 1220, which may integrate one or more of the systems 100, 120, and/or 150 therein. In the embodiment of FIG. 12, the wireless transmission system 120 is operatively associated with the mouse pad 1220 and the wireless receiver system 150 is operatively associated with a computer mouse 1230, as the computer mouse 1230 is the electronic 140 associated with the wireless receiver system 150. The wireless receiver system 150 may be configured to provide power to the load 160 of the electronic device 140 (e.g., the computer mouse 1230). The large area transmission antennas 121, 900A-C may be configured to generate a charge area over most or all of the operating surface 1222 of the mouse pad 1220 and the system 100 may be configured to charge the load 160 of the mouse 1230, when the mouse 1230 is in use and in motion.

With respect to any of the data transmission systems disclosed herein, it should be appreciated that either or both of the wireless power sender and the wireless power receiver may wirelessly send in-band legacy data. Moreover, the systems, methods, and apparatus disclosed herein are designed to operate in an efficient, stable and reliable manner to satisfy a variety of operating and environmental conditions. The systems, methods, and/or apparatus disclosed herein are designed to operate in a wide range of thermal and mechanical stress environments so that data and/or electrical energy is transmitted efficiently and with minimal loss. In addition, the system 100 may be designed with a small form factor using a fabrication technology that allows for scalability, and at a cost that is amenable to developers and adopters. In addition, the systems, methods, and apparatus disclosed herein may be designed to operate over a wide range of frequencies to meet the requirements of a wide range of applications.

In an embodiment, a ferrite shield may be incorporated within the antenna structure to improve antenna performance. Selection of the ferrite shield material may be dependent on the operating frequency as the complex magnetic permeability (μ=μ′−j*μ″) is frequency dependent. The material may be a polymer, a sintered flexible ferrite sheet, a rigid shield, or a hybrid shield, wherein the hybrid shield comprises a rigid portion and a flexible portion. Additionally, the magnetic shield may be composed of varying material compositions. Examples of materials may include, but are not limited to, zinc comprising ferrite materials such as manganese-zinc, nickel-zinc, copper-zinc, magnesium-zinc, and combinations thereof.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination. As a further example, it will be appreciated that certain protocols are used as specific example communications schemes herein, other wired and wireless communications techniques may be used where appropriate while embodying the principles of the present disclosure.

What is claimed is:

1. A wireless power transmission system comprising:
an input power stabilization system comprising a proportional integral (PI) controller, the input power stabilization system configured to receive an input power from an external power source and generate a stabilized direct current (DC) power based on a desired input power;
a controller comprising:
at least one processor,
at least one machine-readable medium, and
program instructions stored on the at least one machine-readable medium
which, when executed by the at least one processor, cause the controller to generate a driving signal for alternating current (AC) wireless signals, the AC wireless signals including wireless power signals;
an amplifier configured to (i) receive the stabilized DC power and antenna driving signals, (ii) invert the stabilized DC power based on the driving signals to generate alternating current (AC) wireless signals; and
an antenna configured to transmit the AC wireless signals when driven by the amplifier.

2. The wireless power transmission system of claim 1, wherein the input power stabilization system further comprises an input current sensing circuit configured to continuously determine an input current of the input power over time.

3. The wireless power transmission system of claim 2, wherein the input power stabilization system further comprises a differentiator circuit configured to (i) receive the input current of the input power over time, (ii) define a reference value for a stabilized input current, (iii) compare the input current of the input power over time with the reference value for the stabilized input current, and (iv) determine and output an error value based on comparison of the input current of the input power over time with the reference value for the stabilized input current.

4. The wireless power transmission system of claim 3, wherein the PI controller is configured to (i) receive the error value and (ii) determine and output the stabilized DC power based on the error value.

5. The wireless power transmission system of claim 3, wherein the PI controller further comprises an inversion circuit.

6. The wireless power transmission system of claim 3, wherein the input power stabilization system further comprises an upper saturation circuit.

7. The wireless power transmission system of claim 3, wherein the input power stabilization system further comprises a lower saturation circuit.

8. The wireless power transmission system of claim 1, further comprising a power input port, the power input port comprising one or more of a universal serial bus (USB) Type-A port, a USB-micro port, a USB Type-B port, or combinations thereof.

9. The wireless power transmission system of claim 1, wherein the program instructions stored on the at least one machine-readable medium which, when executed by the at least one processor, further cause the controller to decode data signals that are encoded in the AC wireless signals based on a period-length encoding scheme, the period-length encoding scheme starting at least one message of the data signals with a leading edge and ending the at least one message of the data signals with a trailing edge.

10. The wireless power transmission system of claim 9, further comprising:
at least one sensor configured to detect electrical information associated with electrical characteristics of the AC wireless signals at the antenna, the electrical information including one or more of a current of the AC wireless signals, a voltage of the AC wireless signals, a power level of the AC wireless signals, or combinations thereof; and
a demodulation circuit configured to (i) receive the electrical information from the at least one sensor, (ii) detect a change in the electrical information, (iii) determine if the change in the electrical information meets or exceeds one of a rise threshold or a fall threshold, (iv) if the change exceeds one of the rise threshold or the fall threshold, generate an alert, (v) and output a plurality of data alerts, and
wherein the controller is configured to receive the plurality of data alerts, and
wherein the program instructions stored on the at least one machine-readable medium, when executed by the at least one processor, cause the controller to decode data signals that are encoded in the AC wireless signals comprises decoding the plurality of data alerts.

11. A method of operating a wireless transmission system, the method comprising:
receiving input power from an external power source;
generating, using an input power stabilization system comprising a proportional integral (PI) controller, a stabilized direct current (DC) power based on a desired input power and the input power;
generating, using a controller, a driving signal for alternating current (AC) wireless signals, the AC wireless signals including wireless power signals;
inverting, using an amplifier, the stabilized DC power based on the driving signals to thereby generate the AC wireless signals; and
driving, using the amplifier, an antenna to thereby, via the antenna, transmit the AC wireless signals.

12. The method of claim 11, further comprising determining, using an input current sensing circuit, an input current of the input power, over time.

13. The method of claim 12, further comprising:
defining a reference value for a stabilized input current;
comparing the input current of the input power over time with the reference value for the stabilized input current; and
determining an error value based on comparison of the input current of the input power over time with the reference value for the stabilized input current.

14. The method of claim 13, further comprising determining the stabilized DC power based on the error value.

15. The method of claim 13, wherein the PI controller further comprises an inversion circuit.

16. The method of claim 13, wherein the input power stabilization system further comprises an upper saturation circuit.

17. The method of claim 13, the input power stabilization system further comprises a lower saturation circuit.

18. The method of claim 11, wherein receiving input power from an external power source comprises receiving input power from one or more of a universal serial bus (USB) Type-A port, a USB-micro port, a USB Type-B port, or combinations thereof.

19. The method of claim 11, further comprising decoding data signals that are encoded in the AC wireless signals based on a period-length encoding scheme, the period-length encoding scheme starting at least one message of the data signals with a leading edge and ending the at least one message of the data signals with a trailing edge.

20. The method of claim 19, further comprising:
detecting electrical information associated with electrical characteristics of the AC wireless signals at the antenna, the electrical information including one or more of a current of the AC wireless signals, a voltage of the AC wireless signals, a power level of the AC wireless signals, or combinations thereof;
detecting a change in the electrical information;
determining if the change in the electrical information meets or exceeds one of a rise threshold or a fall threshold; and
if the change exceeds one of the rise threshold or the fall threshold, generating an alert.
